(19) United States
(12) Patent Application Publication
(10) Pub. No.: US 2024/0239921 A1
(43) Pub. Date: Jul. 18, 2024

(54) COMPOSITIONS COMPRISING OXIDIZED INSOLUBLE ALPHA-GLUCAN

(71) Applicant: NUTRITION & BIOSCIENCES USA 4, INC., Rochester, NY (US)

(72) Inventor: LEMUEL TONG, KINGSTON (CA)

(21) Appl. No.: 18/557,601

(22) PCT Filed: May 4, 2022
(86) PCT No.: PCT/US22/27587

§ 371 Date: Oct. 27, 2023

(51) Int. Cl. C08B 37/00; B60C 1/00; C08J 3/00; C08L 7/02

(52) U.S. Cl. CPC C08B 37/0009; B60C 1/00; C08J 3/005; C08L 7/02; C08J 2307/02; C08J 2405/00

(57) ABSTRACT

Compositions are disclosed herein, for example, comprising oxidized insoluble alpha-glucan and a rubber component, wherein crystalline insoluble alpha-glucan is used to produce the oxidized insoluble alpha-glucan component(s). Additional compositions disclosed herein include those comprising oxidized insoluble alpha-glucan and a rubber component. Methods are further disclosed for preparing these compositions, as well as various applications of using them. Other compositions comprising oxidized crystalline insoluble alpha-glucan are also disclosed.

This application claims the benefit of U.S. Provisional Appl. No. 63/183,841 (filed May 4, 2021), which is incorporated herein by reference in its entirety.

### FIELD

The present disclosure is in the field of polysaccharides. For example, the disclosure pertains to rubber compositions comprising insoluble alpha-glucan that has been oxidized, and use of this material in various applications.

### BACKGROUND

Rubber compositions are typically reinforced with particulates such as carbon black and silica to improve performance characteristics and reduce cost. Such rubber compositions are extensively used in various applications ranging from tires to belts to footwear, because of their excellent static and dynamic mechanical, physical, and thermal properties.

Depending on their effect on the mechanical performance of rubber compositions, fillers can generally be classified as reinforcing, semi-reinforcing, or non-reinforcing (extending). While reinforcing fillers improve the mechanical properties of rubber compositions, non-reinforcing fillers simply act as diluents, and semi-reinforcing fillers perform both functions to some extent. The effect of fillers on rubber compositions is related to the intrinsic properties of the filler such as particle size and distribution, particle shape, and the interfacial interaction between the rubber polymer/elastomer and the filler. Although carbon black is the dominant filler used in the rubber industry due to its reinforcing effect, other fillers such as carbonates, clays, silicas, silicates, talc, and titanium dioxide are also used.

There is growing interest in replacing or complementing carbon black in rubber compositions with renewable fillers. Renewable materials can offer an improved environmental footprint over that associated with processes of producing carbon black from oil and gas, and reduced energy consumption in the processing of rubber with the renewable filler. Tire manufacturers, for example, are interested in rubber compositions that provide low rolling resistance, high wet traction, and long lifetime. There is significant interest in rubber compositions that can provide energy savings through better processability, lighter weight, reduced cost, and inclusion of renewable ingredients without compromising performance.

Thus, there is a growing need for renewable materials that can replace incumbent ingredients in rubber compositions while providing improved properties. Described herein are rubber compositions comprising oxidized insoluble alpha-glucan to address this need. Other types of compositions comprising oxidized insoluble alpha-glucan are also disclosed.

### SUMMARY

In one embodiment, the present disclosure concerns a composition comprising at least oxidized insoluble alpha-glucan and a rubber component, wherein the oxidized insoluble alpha-glucan is produced by contacting an insoluble alpha-glucan under aqueous conditions with at least one agent that is capable of oxidizing the insoluble alpha-glucan, wherein (i) at least about 50% of the glycosidic linkages of the insoluble alpha-glucan are alpha-1,3 glycosidic linkages, (ii) the insoluble alpha-glucan has a weight-average degree of polymerization (DPw) of about 10 (or 15) to 100, and (iii) the insoluble alpha-glucan is in the form of particles having a degree of crystallinity of at least about 0.65.

In another embodiment, the present disclosure concerns a method of producing a rubber composition as presently disclosed, the method comprising: (a) providing an aqueous dispersion comprising a mixture the oxidized insoluble alpha-glucan and the rubber component, (b) coagulating the dispersion/mixture to produce a coagulated mass, and (c) optionally drying the coagulated mass.

### DETAILED DESCRIPTION

The disclosures of all cited patent and non-patent literature are incorporated herein by reference in their entirety.

Unless otherwise disclosed, the terms “a” and “° an” as used herein are intended to encompass one or more (i.e., at least one) of a referenced feature.

Where present, all ranges are inclusive and combinable, except as otherwise noted. For example, when a range of “1 to 5” (i.e., 1-5) is recited, the recited range should be construed as including ranges “1 to 4” “1 to 37,” 1-2′, “1-2 & 4-5”, “1-3 & 5”, and the like. The numerical values of the various ranges in the present disclosure, unless expressly indicated otherwise, are stated as approximations as though the minimum and maximum values within the stated ranges were both proceeded by the word “about”. In this manner, slight variations above and below the stated ranges can typically be used to achieve substantially the same results as values within the ranges. Also, the disclosure of these ranges is intended as a continuous range including each and every value between the minimum and maximum values.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

It is to be appreciated that certain features of the present disclosure, which are, for clarity, described above and below in the context of aspects/embodiments, may also be provided in combination in a single element. Conversely, various features of the disclosure that are, for brevity, described in the context of a single aspect/embodiment, can also be provided separately or in any sub-combination.

The term “polysaccharide” (or “glycan”) means a polymeric carbohydrate molecule composed of long chains of monosaccharide units bound together by glycosidic linkages and on hydrolysis gives the polysaccharide's constituent monosaccharides and/or oligosaccharides. A polysaccharide herein can be linear or branched, and/or can be a homopolysaccharide (comprised of only one type of constituent monosaccharide) or heteropolysaccharide (comprised of two or more different constituent monosaccharides). An example of a polysaccharides herein is glucan (polyglucose).

The term “saccharide” and other like terms herein refer to monosaccharides and/or disaccharides/oligosaccharides, unless otherwise noted. A “disaccharide” herein refers to a carbohydrate having two monosaccharides joined by a glycosidic linkage. An “oligosaccharide” herein can refer to a carbohydrate having 3 to 15 monosaccharides, for example, joined by glycosidic linkages. An oligosaccharide can also be referred to as an “oligomer”. Monosaccharides (e.g., glucose and/or fructose) comprised within disaccharides/oligosaccharides can be referred to as “monomeric units”, “monosaccharide units”, or other like terms.

A “glucan” herein is a type of polysaccharide that is a polymer of glucose (polyglucose). A glucan can be comprised of, for example, about, or at least about, 90%, 91%, 92%, 93%, 94%, 95%, 96%, 97%, 98%, 99%, or 100% by weight glucose monomeric units. Examples of glucans herein include alpha-glucans.

The terms “alpha-glucan”, “alpha-glucan polymer” and the like are used interchangeably herein. An alpha-glucan is a polymer comprising glucose monomeric units linked together by alpha-glycosidic linkages. In typical aspects, the glycosidic linkages of an alpha-glucan herein are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. Examples of an alpha-glucan polymer herein include alpha-1,3-glucan.

The terms “alpha-1,3-glucan”, “poly alpha-1,3-glucan”, “alpha-1,3-glucan polymer” and the like are used interchangeably herein. Alpha-1,3-glucan is an alpha-glucan comprising glucose monomeric units linked together by glycosidic linkages, wherein at least about 50% of the glycosidic linkages are alpha-1,3. Alpha-1,3-glucan in some aspects comprises about, or at least about, 90%, 95%, or 100% alpha-1,3 glycosidic linkages. Most or all of the other linkages, if present, in alpha-1,3-glucan herein typically are alpha-1,6, though some linkages may also be alpha-1,2 and/or alpha-1,4. Alpha-1,3-glucan herein is typically water-insoluble.

The terms “dextran”, “dextran polymer”, “dextran molecule”, “alpha-1,6-glucan” and the like in some aspects herein refer to a water-soluble alpha-glucan comprising at least 50%, 60%, 70%, 80%, 90%, 95%, 96%, 97%, 98%, 99%, or 99.5% alpha-1,6 glycosidic linkages (with the balance of the linkages typically being all or mostly alpha-1,3).

The term “copolymer” herein refers to a polymer comprising at least two different types of alpha-glucan, such as dextran and alpha-1,3-glucan. The terms “graft copolymer”, “branched copolymer” and the like herein generally refer to a copolymer comprising a “backbone” (or “main chain”) and side chains branching from the backbone. The side chains are structurally distinct from the backbone. Examples of graft copolymers herein comprise a dextran backbone (or dextran backbone that has been modified with about 1%-35% alpha-1,2 and/or alpha-1,3 branches, e.g.), and at least one side chain of alpha-1,3-glucan comprising at least about 50% alpha-1,3 glycosidic linkages. An alpha-1,3-glucan side chain herein can have a linkage and molecular weight of alpha-1,3-glucan as disclosed herein, for example. In some aspects, a dextran backbone can have an alpha-1,3-glucan extension, since the non-reducing end(s) of dextran can prime alpha-1,3-glucan synthesis by a glucosyltransferase enzyme.

The terms “linkage”, “glycosidic linkage”, “glycosidic bond” and the like refer to the covalent bonds connecting the sugar monomers within a saccharide compound (oligosaccharides and/or polysaccharides). Examples of glycosidic linkages include 1,6-alpha-D-glycosidic linkages (herein also referred to as “alpha-1,”6 linkages) and 1,3-alpha-D-glycosidic linkages (herein also referred to as “alpha-1,3” linkages). The glycosidic linkages of a glucan polymer herein can also be referred to as “glucosidic linkages”. Herein, “alpha-D-glucose” will be referred to as “glucose”.

The glycosidic linkage profile of a polysaccharide or derivative thereof can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry. Physical Properties, and Applications (S. W. Cui, Ed., Chapter 3, S. W. Cui, Structural Analysis of Polysaccharides, Taylor & Francis Group LLC, Boca Raton, F L, 2005), which is incorporated herein by reference.

An “alpha-1,2 branch” (and like terms) as referred to herein typically comprises a glucose that is alpha-1,2-linked to a dextran backbone; thus, an alpha-1,2 branch herein can also be referred to as an alpha-1,2,6 linkage. An alpha-1,2 branch herein typically has one glucose group (can optionally be referred to as a pendant glucose).

An “alpha-1,3 branch” (and like terms) as referred to herein typically comprises a glucose that is alpha-1,3-linked to a dextran backbone; thus, an alpha-1,3 branch herein can also be referred to as an alpha-1,3,6 linkage. An alpha-1,3 branch herein typically has one glucose group (can optionally be referred to as a pendant glucose).

The percent branching in a polysaccharide herein refers to that percentage of all the linkages in the polysaccharide that represent branch points. For example, the percent of alpha-1,3 branching in an alpha-glucan herein refers to that percentage of all the linkages in the glucan that represent alpha-1,3 branch points. Except as otherwise noted, linkage percentages disclosed herein are based on the total linkages of a polysaccharide, or the portion of a polysaccharide for which a disclosure specifically regards.

The “molecular weight” of a polysaccharide or polysaccharide derivative herein can be represented as weight-average molecular weight (Mw) or number-average molecular weight (Mn), the units of which are in Daltons (Da) or grams/mole. Alternatively, molecular weight can be represented as DPw (weight average degree of polymerization) or DPn (number average degree of polymerization). The molecular weight of smaller polysaccharide polymers such as oligosaccharides can optionally be provided as “DP” (degree of polymerization), which simply refers to the number of monomers comprised within the polysaccharide; “DP” can also characterize the molecular weight of a polymer on an individual molecule basis. Various means are known in the art for calculating these various molecular weight measurements such as with high-pressure liquid chromatography (HPLC), size exclusion chromatography (SEC), or gel permeation chromatography (GPC).

As used herein, Mw can be calculated as Mw=ΣNiMi²/ΣNiMi; where Mi is the molecular weight of an individual chain i and Ni is the number of chains of that molecular weight. Besides SEC, the Mw of a polymer can be determined by other techniques such as static light scattering, mass spectrometry, MALDI-TOF (matrix-assisted laser desorptioniionization time-of-flight), small angle X-ray or neutron scattering, or ultracentrifugation. As used herein, Mn can be calculated as Mn=ΣNiMi/ΣNi where Mi is the molecular weight of a chain i and Ni is the number of chains of that molecular weight. Besides SEC, the Mn of a polymer can be determined by various colligative property methods such as vapor pressure osmometry, end-group determination by spectroscopic methods such as proton NMR, proton FTIR, or UV-Vis. As used herein, DPn and DPw can be calculated from Mw and Mn, respectively, by dividing them by molar mass of the one monomer unit M₁. In the case of unsubstituted glucan polymer, M₁=162. In the case of a substituted (derivatized) glucan polymer, M₁=162+M_{f}×DoS, where M_{f} is molar mass of the substituting group, and DoS is degree of substitution (average number of substituted groups per one glucose unit of the glucan polymer).

The terms “crystalline”, “crystalline solid”, “crystal” and like terms herein refer to a solid material whose constituents are arranged in a regularly ordered structure forming a lattice; such material typically is a portion of a larger composition having both crystalline and amorphous regions. An “amorphous” material is non-crystalline in that its constituents are not organized in a definite lattice pattern, but rather are randomly organized. Crystalline materials, but not amorphous materials, usually have a characteristic geometric shape (e.g., plate). The terms “crystallinity”, “crystallinity index” (CI), “degree of crystallinity” and the like herein refer to the fractional amount (mass fraction or volume fraction) of an insoluble alpha-glucan that is crystalline, and can be referred to in decimal or percentage form (e.g., a crystallinity of 0.65 corresponds to a crystallinity of 65%). This fractional amount is of a total amount or volume that includes the amorphous content of the insoluble alpha-glucan. Crystallinity herein can be as measured using techniques such as differential scanning calorimetry (DSC), X-ray diffraction (XRD), small angle X-ray scattering (SAXS), infrared spectroscopy, and/or density measurements according to, for example, Struszczyk et al. (1987, J. Appl. Polym. Sci. 33:177-189), U.S. Patent Appl. Publ. Nos. 2015/0247176, 2010/0233773, 2015/0152196, or 2020/10181370, or Int. Patent Appl. Publ. No. WO2018/081263, which are all incorporated herein by reference. In some aspects, the crystallinity of insoluble alpha-1,3-glucan herein can be as determined according to the methodology disclosed in the below Examples (Materials/Methods).

The terms “particle”, “particulate” and like terms are interchangeably used herein, and refers to the smallest identifiable unit in a particulate system. The term “particulated” and like terms can be used to characterize particles of insoluble alpha-glucan herein; particulated insoluble alpha-glucan in typical aspects of the present disclosure is as this material exists when dispersed under aqueous conditions. Particle size in some aspects can refer to particle diameter and/or the length of the longest particle dimension. The average size can be based on the average of diameters and/or longest particle dimensions of at least 50, 100, 500, 1000, 2500, 5000, or 10000 or more particles, for example. Particles herein can be in plate form, for instance. Particle size herein can be measured by a process comprising light scattering or electrical impedance change (e.g., using a Coulter Counter), for example, such as described in any of U.S. Pat. Nos. 6,091,492, 6,741,350, or 9297737 (each incorporated herein by reference). Particle size and/or distributions can be as measured for particles comprised in an aqueous dispersion, for example. Particle size herein can optionally be expressed by a “D₁₀”, “D₅₀”, “D₉₀”, etc. value; for example, a D₅₀ value is the diameter for which 50% by weight of the particles in a composition (e.g., dispersion) have a diameter under that diameter, and 50% by weight of the particles have a diameter greater than that diameter.

The terms “plate”, “platy”, “plate-like”, “flakey” and like terms herein characterize the shape of insoluble alpha-glucan particles in some aspects. Particles having this shape herein generally are flat (more two-dimensional than three-dimensional), as opposed to being spherical, cylindrical, fibrillar, fibrous, rod-like, cubic, acicular, spongey/porous, lamellar, or of some other shape. Particles herein can optionally be referred to as “plates”, “platelets”, and like terms, and/or collectively as “microcrystalline glucan” and like terms.

The term “hydrolysis” and like terms herein refer to the decomposition of insoluble alpha-glucan to smaller (lower molecular weight), but still insoluble, alpha-glucan, where water is consumed in cleaving glycosidic linkages of the insoluble alpha-glucan. A “hydrolysis reaction”, “hydrolysis reaction composition”, or like term herein typically refers to a reaction that initially comprises at least an aqueous liquid, insoluble alpha-glucan, and a hydrolyzing agent (e.g., chemical, catalyst/enzyme). An acid hydrolysis reaction as referred to herein comprises acid as a hydrolyzing agent; the pH of an acid hydrolysis reaction herein can be 4.0 or below, for example.

An “oxidized insoluble alpha-glucan” (and like terms) herein refers to an insoluble compound resulting from oxidation of an insoluble alpha-glucan such as presently disclosed (e.g., one with a crystallinity index of at least 0.65; such an oxidized glucan can optionally be referred to as “oxidized crystalline insoluble alpha-glucan” or the like). Such oxidation can occur, for example, at one or more hydroxyl groups of monomeric units of an insoluble alpha-glucan. Oxidation can independently convert hydroxyl groups to an aldehyde, ketone, or carboxylic group. An insoluble alpha-glucan herein can be oxidized by contacting it with one or more oxidizing/oxidation agents under aqueous conditions, for example. Some aspects of the present disclosure are drawn to an oxidized insoluble alpha-glucan produced by contacting an insoluble alpha-glucan with a crystallinity index of at least 0.65 under aqueous conditions with at least one agent that is capable of oxidizing the insoluble alpha-glucan (regardless of whether or not it is present in a rubber composition herein).

“Aqueous conditions” and like terms regarding an oxidation reaction herein refer to a solution or mixture in which the solvent is at least about 60 wt % water, for example. An oxidation reaction herein can be performed under aqueous conditions. Aqueous conditions can be acidic or basic, for example.

The terms “rubber component”, “rubber”, and “elastomer” herein may be used interchangeably, unless expressly indicated otherwise. The terms “rubber compound”, “compounded rubber”. “rubber composition” and like terms may be used interchangeably to refer to rubber that has been blended/mixed with one or more other ingredients (aside from another rubber; e.g., oxidized crystalline insoluble alpha-glucan herein, optionally with another additive herein).

The terms “cure” “vulcanize” and the like herein may be used interchangeably unless otherwise indicated. Rubber compounds are typically cured using sulfur- or peroxide-based curing agents. Typical sulfur-based curing agents for rubber compounds include elemental sulfur, sulfur-containing resins, sulfur-olefin adducts, and cure accelerators.

The term “parts-per-hundred rubber/resin” (“phr”) herein refers to parts by weight of a respective material per 100 parts by weight of a rubber component.

As used herein, the terms “masterbatch”, “masterbatch composition”, “coagulum” and the like refer to a solid product in which a desired component is optimally dispersed (e.g., at high concentration) in a carrier material comprising a rubber component herein. In a masterbatch of the present disclosure, the desired component is compatible with the rubber component with which it will be further blended during compounding, whereby the final rubber product (compounded) obtains the desired component and its properties from the masterbatch. A masterbatch composition herein includes at least one oxidized insoluble alpha-glucan and at least one rubber component derived from a rubber latex. Use of a masterbatch composition herein typically provides the property benefits offered by the oxidized alpha-glucan component.

As used herein, “filler” and like terms mean particles or material added to a rubber composition to lower the amount of more expensive material in the composition, and/or to improve the properties of the composition.

As used herein, “anti-ozonant” and like terms mean an organic compound used to prevent or retard degradation caused by ozone.

As used herein, “processing aid” and like terms mean a compound added to a rubber composition during its preparation to allow easier mixing and/or extrusion.

As used herein, “compatibilizer” and like terms mean a compound that promotes interfacial adhesion between immiscible polymers.

As used herein, “bonding agent” and like terms mean a substance applied to a substrate to create a bond between it and a succeeding layer.

As used herein, “tackifier” and like terms mean a low-molecular weight compound with high glass transition temperature used in formulating adhesives to increase tack.

As used herein, “accelerator” and like terms mean a compound added to a rubber compound to increase the speed of vulcanization and to permit vulcanization to proceed at lower temperature and with greater efficiency.

As used herein, “coupling agent” and like terms mean a compound that provides a chemical bond between two dissimilar materials, such as an inorganic material and an organic material.

A “cake” of insoluble alpha-glucan herein refers to a preparation in condensed, compacted, packed, squeezed, and/or compressed form that comprises at least (i) about 50%-90% by weight water or an aqueous solution, and (ii) about 10%-50% by weight insoluble alpha-glucan. A cake in some aspects can be referred to as a “filter cake” or a “wet cake”. A cake herein typically has a soft, solid-like consistency.

The term “fibrids”, “alpha-1,3-glucan fibrids”, “fibrillated glucan” and the like as used herein can refer to nongranular, fibrous, or film-like particles with at least one of their three dimensions being of minor magnitude relative to the largest dimension. In some aspects; an alpha-1,3-glucan fibrid can have a fiber-like and/or a sheet-like structure with a relatively large surface area when compared to an alpha-1,3-glucan fiber. The surface area of fibrids herein can be about 5 to 50 meter²/gram of material, with the largest dimension of about 10 to 1000 microns and the smallest dimension of 0.05 to 0.25 microns (aspect ratio of largest to smallest dimension of 40 to 20000.

A composition herein comprising insoluble alpha-glucan that is “dry” or “dried” typically has less than 12, 11, 10, 9, 8, 7, 6, 5, 4, 3, 2, 1, 0.5, or 0.1 wt % water comprised therein.

The terms “aqueous liquid”, “aqueous fluid”, “aqueous conditions”, “aqueous reaction conditions”, “aqueous setting” “aqueous system” and the like as used herein can refer to water or an aqueous solution. An “aqueous solution” herein can comprise one or more dissolved salts, where the maximal total salt concentration can be about 3.5 wt % in some aspects. Although aqueous liquids herein typically comprise water as the only solvent in the liquid, an aqueous liquid can optionally comprise one or more other solvents (e.g., polar organic solvent) that are miscible in water. Thus, an aqueous solution can comprise a solvent having at least about 10 wt % water.

An “aqueous composition” herein has a liquid component that comprises about, or at least about, 10, 20, 30, 40, 50, 60, 70, 80, 90, 95, 99, or 100 wt % water, for example. Examples of aqueous compositions include mixtures, solutions, dispersions (e.g., colloidal dispersions), suspensions and emulsions, for example.

As used herein, the term “colloidal dispersion” refers to a heterogeneous system having a dispersed phase and a dispersion medium, i.e., microscopically dispersed insoluble particles are suspended throughout another substance (e.g., an aqueous composition such as water or aqueous solution). An example of a colloidal dispersion herein is a hydrocolloid. All, or a portion of, the particles of a colloidal dispersion such as a hydrocolloid can comprise insoluble alpha-glucan or oxidized insoluble alpha-glucan as presently disclosed. The terms “dispersant” and “dispersion agent” are used interchangeably herein to refer to a material that promotes the formation and/or stabilization of a dispersion. “Dispersing” herein refers to the act of preparing a dispersion of a material in an aqueous liquid. As used herein, the term “latex” (and like terms) refers to a dispersion of one or more types of polymer particles in water or aqueous solution; typically, at least particles herein are in a latex composition as a dispersed polymer component. In some aspects, a latex is an emulsion that comprises a dispersion of at least particles herein. An “emulsion” herein is a dispersion of minute droplets of one liquid in another liquid in which the droplets are not soluble or miscible (e.g., a non-polar substance such as oil or other organic liquid such as an alkane, in a polar liquid such as water or aqueous solution). An emulsion can further comprise dispersed insoluble alpha-glucan or oxidized insoluble alpha-glucan herein, for example. In some aspects, however, an emulsion herein can be a “dry emulsion”. A dry emulsion is typically produced by removing all or most (e.g. >95%, >99%, or >99.5%) of the water of a liquid emulsion, such as by freeze-drying or spray-drying.

An alpha-glucan or oxidized alpha-glucan (e.g., oxidized crystalline alpha-glucan) herein that is “insoluble”, “aqueous-insoluble”, “water-insoluble” (and like terms) (e.g., alpha-1,3-glucan with a DP of 8 or higher) herein does not dissolve (or does not appreciably dissolve) in water or other aqueous conditions, optionally where the aqueous conditions are further characterized to have a pH of 4-9 (e.g., pH 6-8) and/or temperature of about 1 to 130° C. (e.g., 20-25° C.). In some aspects, less than 1.0 gram (e.g., no detectable amount) of an aqueous-insoluble alpha-glucan or oxidized alpha-glucan herein dissolves in 1000 milliliters of such aqueous conditions (e.g., water at 23° C.). In contrast, glucans such as certain oligosaccharides herein that are “soluble”, “aqueous-soluble”, “water-soluble” and the like (e.g., alpha-1,3-glucan with a DP less than 8) appreciably dissolve under these conditions.

The term “viscosity” as used herein refers to the measure of the extent to which a fluid (aqueous or non-aqueous) resists a force tending to cause it to flow. Various units of viscosity that can be used herein include centipoise (cP, cps) and Pascal-second (Pa·s), for example. A centipoise is one one-hundredth of a poise; one poise is equal to 0.100 kg·m⁻¹·s⁻¹. Viscosity can be reported as “intrinsic viscosity” (IV, rq, units of dL/g) in some aspects; this term refers to a measure of the contribution of a glucan polymer to the viscosity of a liquid (e.g., solution) comprising the glucan polymer, IV measurements herein can be obtained, for example, using any suitable method such as disclosed in U.S. Pat. Appl Publ. Nos. 2017/0002335, 2017/0002336, or 2018/0340199, or Weaver et al. (J Appl. Polym Sci. 35:1631-1637) or Chun and Park (Macromot. Chem. Phys. 195:701-711), which are all incorporated herein by reference. IV can be measured, in part, by dissolving glucan polymer (optionally dissolved at about 100° C. for at least 2, 4, or 8 hours) in DMSO with about 0.9 to 2.5 wt % (e.g., 1, 2, 1-2 wt %.) LiCl, for example. IV herein can optionally be used as a relative measure of molecular weight.

The terms “household care product”, “home care product”, and like terms typically refer to products, goods and services relating to the treatment, cleaning, caring, and/or conditioning of a home and its contents. The foregoing includes, for example, chemicals, compositions, products, or combinations thereof having application in such care.

A “fabric care composition”, “laundry care composition”, and like terms refer to any composition suitable for treating fabric, non-wovens, and/or any similar material in some manner. Examples of such a composition include laundry detergents and fabric softeners.

A “detergent composition” herein typically comprises at least a surfactant (detergent compound) and/or a builder. A “surfactant” herein refers to a substance that tends to reduce the surface tension of a liquid in which the substance is dissolved. A surfactant may act as a detergent, wetting agent, emulsifier, foaming agent, and/or dispersant, for example.

The terms “heavy duty detergent”, “all-purpose detergent” and the like are used interchangeably herein to refer to a detergent useful for regular washing of white and colored textiles at any temperature. The terms “low duty detergent”, “fine fabric detergent” and the like are used interchangeably herein to refer to a detergent useful for the care of delicate fabrics such as viscose, wool, silk, microfiber or other fabric requiring special care. “Special care” can include conditions of using excess water, low agitation, and/or no bleach, for example.

The terms “builder”, “builder agent” and the like herein refer to compositions that, for example, can complex with hard water cations such as calcium and magnesium cations. Such complex formation is believed to prevent the formation of water-insoluble salts and/or other complexes by the cation(s). In the context of a detergent composition for cleaning or maintenance applications, a builder added thereto typically can enhance or maintain the cleaning efficiency of a surfactant present in the detergent composition. The terms “builder capacity”, “builder activity” and the like are used interchangeably herein and refer to the ability of an aqueous composition to exhibit features endowed by one or more builders present in the aqueous composition.

The term “personal care product” and like terms typically refer to products, goods and services relating to the treatment, cleaning, cleansing, caring or conditioning of a person. The foregoing include, for example, chemicals, compositions, products, or combinations thereof having application in such care.

The term “medical product” and like terms typically refer to products, goods and services relating to the diagnosis, treatment, and/or care of patients.

The term “industrial product” and like terms typically refer to products, goods and services used in industrial or institutional settings, but typically not by individual consumers,

The terms “film”, “sheet” and like terms herein refer to a generally thin, visually continuous material. A film can be comprised as a layer or coating on a material, or can be alone (e.g., not attached to a material surface; free-standing). A “coating” (and like terms) as used herein refers to a layer covering a surface of a material. The term “uniform thickness” as used to characterize a film or coating herein can refer to a contiguous area that (i) is at least 20% of the total film/coating area, and (ii) has a standard deviation of thickness of less than about 50 nm, for example. The term “continuous layer” means a layer of a composition applied to at least a portion of a substrate, wherein a dried layer of the composition covers 99% of the surface to which it has been applied and having less than 1% voids in the layer that expose the substrate surface. The 99% of the surface to which the layer has been applied excludes any area of the substrate to which the layer has not been applied. A coating herein can make a continuous layer in some aspects. A coating composition (and like terms) herein refers to all the solid components that form a layer on a substrate, such as particles herein and, optionally, pigment, surfactant, dispersing agent, binder, crosslinking agent, and/or other additives.

The term “paint” (and like terms) herein is a type of coating composition that is a dispersion of a pigment in a suitable liquid (e.g., aqueous liquid) that can be used to form an adherent coating when spread on a surface in a thin coat. Paint as applied to a surface can provide coloration/decoration, protection, and/or treatment (e.g., primer) to the surface. A paint herein, by virtue of further comprising dispersed particles herein, can optionally be characterized as a latex or latex paint.

A “composite” herein comprises two or more components including a composition (e.g., particles) of the present disclosure. Typically, the components of a composite resist separation and one or more of the components display enhanced and/or different properties as compared to its properties alone, outside the composite (i.e., a composite is not simply an admixture, which generally is easily separable to its original components). A composite herein generally is a solid material, and can be made via an extrusion or molding process, for example. The terms “percent by volume”, “volume percent”, “vol %”, “v/v %” and the like are used interchangeably herein. The percent by volume of a solute in a solution can be determined using the formula: [(volume of solute)/(volume of solution)]×100%.

The terms “percent by weight” “weight percentage (wt %)”, “weight-weight percentage (% w/w)” and the like are used interchangeably herein. Percent by weight refers to the percentage of a material on a mass basis as it is comprised in a composition, mixture, or solution.

The terms “weight/volume percent”, “w/v %” and the like are used interchangeably herein. Weight/volume percent can be calculated as: ((mass [g] of material)/(total volume [mL] of the material plus the liquid in which the material is placed))×100%. The material can be insoluble in the liquid (i.e., be a solid phase in a liquid phase, such as with a dispersion), or soluble in the liquid (i.e., be a solute dissolved in the liquid).

The term “isolated” means a substance (or process) in a form or environment that does not occur in nature. A non-limiting example of an isolated substance includes any oxidized crystalline insoluble alpha-glucan composition disclosed herein. It is believed that the embodiments disclosed herein are synthetic/man-made (could not have been made or practiced except for human intervention/involvement), and/or have properties that are not naturally occurring.

The term “increased” as used herein can refer to a quantity or activity that is at least about 1%, 2%, 3%, 4%, 5%, 6%, 7%, 8%, 9%, 10%, 11%, 12%, 13%, 14%, 15%, 16%, 17%, 18%, 19%, 20%, 50%, 100%, or 200% more than the quantity or activity for which the increased quantity or activity is being compared. The terms “increased”, “elevated” “enhanced”, “greater than”, “improved” and the like are used interchangeably herein.

Some aspects of the present disclosure concern a composition comprising at least oxidized insoluble alpha-glucan and a rubber component, wherein the oxidized insoluble alpha-glucan is produced by contacting an insoluble alpha-glucan under aqueous conditions with at least one agent that is capable of oxidizing the insoluble alpha-glucan, wherein (i) at least about 50% of the glycosidic linkages of the insoluble alpha-glucan are alpha-1,3 glycosidic linkages, (ii) the insoluble alpha-glucan has a weight-average degree of polymerization (DPw) of about 10 (or 15) to 100, and (iii) the insoluble alpha-glucan is in the form of particles having a degree of crystallinity of at least about 0.65. These features of i-iii characterize the insoluble alpha-glucan as it existed before being oxidized herein; however, in some aspects, one or more of these features (e.g., i, i and ii, i and iii, ii and iii, i-lii) can also characterize the oxidized insoluble alpha-glucan. As compared to rubber compositions comprising non-oxidized insoluble alpha-glucan with features i-iii, for example, rubber compositions comprising such insoluble alpha-glucan that has been oxidized have properties of enhanced reinforcement. Oxidized insoluble alpha-glucan herein, such as oxidized crystalline insoluble alpha-glucan, can thus be used, for example, in addition to, or in replacement of, fillers such as carbon black and silica in rubber compositions.

A composition of the present disclosure can comprise insoluble alpha-glucan that has been oxidized, for instance. In some aspects, about, or at least about, 50%, 60%, 70%, 80%, 85%, 90%, 91%, 92%, 93%, 94%, 95%, 96%, 97%, 98%, 99%, 99.5%, or 100% of the glycosidic linkages of the insoluble alpha-glucan, before it has been oxidized (and optionally after it has been oxidized), are alpha-1,3 glycosidic linkages. Typically, the glycosidic linkages that are not alpha-1,3 are mostly or entirely alpha-1,6. It should be understood that the higher the percentage of alpha-1,3 linkages present in an insoluble alpha-glucan, the greater the probability that the glucan is linear, since there are lower occurrences of certain linkages that might be part of branch points. In some aspects, insoluble alpha-glucan has no branch points or less than about 5%, 4%, 3%, 2%, or 1% branch points as a percent of the glycosidic linkages in the alpha-glucan.

In some aspects, insoluble alpha-glucan of the present disclosure, before it has been oxidized (and optionally after it has been oxidized), can have a DRw, DPn, or DP of about, less than about, or at least about, 10, 15, 20, 25, 30, 35, 36, 37, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, 100, 110, 125, 150, 200, 300, 400, 500, 600, 700, 800, 900, 1000, 1100, 1200, 1300, 1400, 1500, 1600, 1700, 1800, 1900, 2000, 2500, 3000, 3500, or 4000. DPw, DPn, or DP can optionally be expressed as a range between any two of these values. Merely as examples, the DPw, DPn, or DP can be about 15-1600, 50-1600, 100-1600, 200-1600, 300-1600, 400-1600, 500-1600, 600-1600, 700-1600, 15-1250, 50-1250, 100-1250, 200-1250, 300-1250, 400-1250, 500-1250, 600-1250, 700-1250, 15-1000, 50-1000, 100-1000, 200-1000, 300-1000, 400-1000, 500-1000, 600-1000, 700-1000, 15-900, 50-900, 100-900, 200-900, 300-900, 400-900, 500-900, 600-900, 700-900, 600-800, or 600-750. Merely as further examples, the DPw, DPn, or DP can be about 10-100, 15-100, 25-100, 35-100, 10-80, 15-80, 25-80, 35-80, 10-60, 15-60, 25-60, 35-60, 10-55, 15-55, 25-55, 35-55, 10-50, 15-50, 25-50, 35-50, 10-45, 15-45, 20-45, 35-45, 35-40, 40-100, 40-80, 40-60, 40-55, 40-50, 45-60, 45-55, 45-50, 15-35, 20-35, 15-30, or 20-30. In some aspects, an insoluble alpha-glucan, before it has been oxidized (and optionally after it has been oxidized), can have a high molecular weight as reflected by high intrinsic viscosity (N); e.g., IV can be about, or at least about 6, 7, 8, 9, 10, 11, 12, 13, 14, 15, 16, 17, 18, 19, 20, 21, 22, 6-8, 6-7, 6-22, 6-20, 6-17, 6-15, 6-12, 10-22, 10-20, 10-17, 10-15, 10-12, 12-22, 12-20, 12-17, or 12-15 dL/g. For comparison purposes, note that the IV of alpha-glucan with at least 90% (e.g., about 99% or 100%) alpha-1,3 linkages and a DPw of about 800 has an IV of about 2-2.5 dL/g. IV herein can be as measured with alpha-glucan polymer dissolved in DMSO with about 0.9 to 2.5 wt % (e.g., 1, 2, 1-2 wt %) LiCl, for example,

Insoluble alpha-glucan in some aspects, before it has been oxidized (and optionally after it has been oxidized), can be as disclosed (e.g., molecular weight, linkage profile, and/or production method) in U.S. Pat. Nos. 7,000,000, 8,871,474, 10,301,604, or 10,260,053, or U.S. Patent Appl. Publ. Nos. 2019/0112456, 2019/0078062, 2019/0078063, 2018/0340199, 2018/0021238, 2018/0273731, 2017/0002335, 2015/0232819, 2015/0064748, 2020/0165360, 2020/0131281, or 2019/0185893, which are each incorporated herein by reference. Insoluble alpha-glucan can be produced, for example, by an enzymatic reaction comprising at least water, sucrose and a glucosyltransferase enzyme that synthesizes the insoluble alpha-glucan. Glucosyltransferases, reaction conditions, and/or processes contemplated to be useful for producing insoluble alpha-glucan can be as disclosed in any of the foregoing references.

In some aspects, a glucosyltransferase enzyme for producing an insoluble alpha-glucan can comprise an amino acid sequence that is 100% identical to, or at least 90%, 91%, 92%, 93%, 94%, 95%, 96%, 97%, 98%, 98.5%, 99%, or 99.5% identical to, SEQ ID NO:2, 4, 6, 8, 10, 12, 14, 16, 18, 20, 26, 28, 30, 34, or 59, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, and have glucosyltransferase activity; these amino acid sequences are disclosed in U.S. Patent Appl. Publ. No. 2019/0078063, which is incorporated herein by reference. It is noted that a glucosyltransferase enzyme comprising SEQ ID NO:2, 4, 8, 10, 14, 20, 26, 28, 30, 34, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, can synthesize insoluble alpha-glucan comprising at least about 90% (˜100%) alpha-1,3 linkages.

In some aspects, insoluble alpha-glucan, before it has been oxidized (and optionally after it has been oxidized), can be in the form of an insoluble graft copolymer such as disclosed in Int. Patent Appl. Publ. Nos. WO2017/079595 or WO2021/247810, or U.S. Patent Appl. Publ. Nos. 2020/0165360, 2019/0185893, or 2020/0131281, which are incorporated herein by reference. A graft copolymer can comprise dextran (as backbone) and alpha-1,3-glucan (as one or more side chains), where the latter component has been grafted onto the former component; typically, this graft copolymer is produced by using dextran or alpha-1,2- and/or alpha-1,3-branched dextran as a primer for alpha-1,3-glucan synthesis by an alpha-1,3-glucan-producing glucosyltransferase as described above. Alpha-1,3-glucan side chain(s) of an alpha-glucan graft copolymer herein can be alpha-1,3-glucan as presently disclosed. Dextran backbone of an alpha-glucan graft copolymer herein can comprise about 100% alpha-1,6 glycosidic linkages (i.e., completely linear dextran backbone), or about, or at least about, 90%, 95%, 96%, 97%, 98%, 99%, or 99.5% alpha-1,6 glycosidic linkages (i.e., substantially linear dextran backbone), and/or have a DP or DPw of about, at least about, or less than about, 3, 4, 5, 6, 7, 8, 9, 10, 11, 12, 13, 14, 15, 16, 17, 18, 19, 20, 21, 22, 23, 24, 25, 26, 27,28, 29, 30, 35, 40, 45, 50, 85, 90, 95, 100, 105, 110, 150, 200, 250, 300, 400, 500, 8-20, 8-30, 8-100, 8-500, 3-4, 3-5, 3-6, 3-7, 3-8,4-5, 4-6, 4-7, 4-8, 5-6, 5-7, 5-8, 6-7, 6-8, 7-8, 90-120, 95-120, 100-120, 105-120, 110-120, 115-120, 90-115, 95-115, 100-115, 105-115, 110-115, 90-110, 95-110, 100-110, 105-110, 90-105, 95-105, 100-105, 90-100, 95-100, 90-95, 85-95, or 85-90, for example. The molecular weight of a dextran backbone in some aspects can be about, or at least about, 0.1, 0.125, 0.15, 0.175, 0.2, 0.24, 0.25, 0.5, 0.75, 1, 2, 3, 4, 5, 6, 7, 8, 9, 10, 20, 30, 40, 50, 60, 70, 80, 90, 100, 110, 120, 130, 140, 150, 160, 170, 180, 190, 200, 0.1-0.2, 0.125-0.175, 0.13-0.17, 0.135-0.165, 0.14-0.16, 0.145-0.155, 10-80, 20-70, 30-60, 40-50, 50-200, 60-200, 70-200, 80-200, 90-200, 100-200, 110-200, 120-200, 50-180, 60-180, 70-180, 80-180, 90-180, 100-180, 110-180, 120-180, 50-160, 60-160, 70-160, 80-160, 90-160, 100-160, 110-160, 120-160, 50-140, 60-140, 70-140, 80-140, 90-140, 100-140, 110-140, 120-140, 50-120, 60-120, 70-120, 80-120, 90-120, 90-110, 100-120, 110-120, 50-110, 60-110, 70-110, 80-110, 90-110, 100-110, 50-100, 60-100, 70-100, 80-100, 90-100, or 95-105 million Daltons. In some aspects, a dextran backbone (before being integrated into a graft copolymer) has been alpha-1,2-and/or alpha-1,3-branched; the percent alpha-1,2 and/or alpha-1,3 branching of a backbone of a graft copolymer herein can be about, at least about, or less than about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 30%, 35%, 40%, 45%, 50%, 2-25%, 2-20%, 2-15%, 2-10%, 5-25%, 5-20%, 5-15%, 5-10%, 7-13%, 8-12%, 9-11%, 10-25%, 10-20%, 10-15%, 10-22%, 12-20%, 12-18%, 14-20%, 14-18%, 15-18%, or 15-17%, for example. The dextran portion of a graft copolymer herein can be as disclosed (e.g., molecular weight, linkage/branching profile, production method), for example, in U.S. Patent Appl. Publ. Nos. 2016/0122445, 2017/0218093, 2018/0282385, 202010165360, or 2019/0185893, which are each incorporated herein by reference. In some aspects, a dextran can be one produced in a suitable reaction comprising glucosyltransferase (GTF) 0768 (SEQ ID NO:1 or 2 of US2016/0122445), GTF 8117, GTF 6831, or GTF 5604 (these latter three GTF enzymes are SEQ ID NOs:30, 32 and 33, respectively, of US2018/0282385), or a GTF comprising an amino acid sequence that is at least 90%, 91%, 92%, 93%, 94%, 95%, 96%, 97%, 98%, or 99% identical to the amino acid sequence of GTF 0768, GTF 8117, GTF 6831, or GTF 5604. In some aspects, an alpha-glucan graft copolymer can comprise: (A) an alpha-1,6-glucan backbone (100% alpha-1,6-linked before alpha-1,2 and/or alpha-1,3 branching) that (i) has been branched with about 10-22% (e.g., about 12-20%, 12-18%, 14-20%, 14-18%, 15-18%, 15-17%, or 16%) alpha-1,2 and/or alpha-1,3 linkages (i.e., alpha-1,2,6 and/or alpha-1,3,6) (e.g., the backbone in total comprises about 82-86% or 84% alpha-1,6 linkages and about 14-18% or 16% alpha-1,2 and/or alpha-1,3 linkages) and (ii) has an Mw of about 15-25, 15-22.5, 17-25, 17-22.5, 18-22, or 20 kDa, and (B) one or more (e.g., two, three, four, five, or six) alpha-1,3-glucan side chains that have been extended from one or more of the alpha-1,2 and/or alpha-1,3 branches; such a graft copolymer typically is water-insoluble.

Insoluble alpha-glucan for use in preparing a composition of the present disclosure can be in the form of particles in some aspects. As comprised in an aqueous composition such as a dispersion, about 40-60%, 40-55%, 45-60%, 45-55%, 47-53%, 48-52%, 49-51%, or 50% by weight of such insoluble alpha-glucan particles have a diameter (i.e., D₅₀) of about, less than about, or at least about, 1, 2, 3, 45, 6, 7, 8, 9, 10, 11, 12, 13, 14, 15, 16, 17, 18, 19, 20, 21, 22, 23, 24, 25, 1-25, 1-22, 1-20, 1-18, 5-25, 5-22, 5-20, 5-18, 15-22, 15-20, 15-18, 16-22, 16-20, or 16-18 microns, for example. Such particles can be as they exist before being oxidized, and optionally as they exist after being oxidized.

Insoluble alpha-glucan herein, before and after it has been oxidized, typically does not have any chemical derivatization (aside from oxidation, if already oxidized) (e.g., etherification, esterification, phosphorylation, sulfation, carbamation; no substitution of hydrogens of glucan hydroxyl groups with a non-sugar chemical group). However, in some aspects, insoluble alpha-glucan (before it has been oxidized, and optionally after it has been oxidized) can be a charged (e.g., cationic or anionic) derivative of an alpha-glucan as disclosed herein. The DoS of such a derivative typically is less than about 0.3, 0.25, 0.2, 0.15, 0.1, or 0.05. The type of derivative can be an ether or ester derivative, for example. Typically, insoluble alpha-glucan herein is enzymatically derived in an inert vessel (typically under cell-free conditions) and is not derived from a cell wall (e.g., fungal cell wall).

In some aspects, insoluble alpha-glucan, before it has been oxidized (and optionally after it has been oxidized), is in the form of particles having a degree of crystallinity (or crystallinity index [Cl]) of at least about 0.65. In some aspects, the degree of crystallinity can be about, or at least about, 0.55, 0.60, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.60-0.83, 0.65-0.83, 0.67-0.83, 0.69-0.83, 0.60-0.81, 0.65-0.81, 0.67-0.81, 0.69-0.81, 0.60-0.78, 0.65-0.78, 0.67-0.78, 0.69-0.78, 0.60-0.76, 0.65-0.76, 0.67-0.76, or 0.69-0.76, for example. In general, that portion of insoluble alpha-glucan herein that is not crystalline is amorphous. Flowing from the foregoing crystallinity values, the wt % of particles that is amorphous is about, or less than about, 45%, 40%, 35%, 30%, 25%, 20%, or 15%, for example. The degree of crystallinity of alpha-glucan particles herein can be as when measured according to any suitable method, such as follows. A sample of insoluble alpha-glucan herein (before or after oxidation) is dried for at least about 2 hours (e.g., 8-12 hours) in a vacuum oven set at about 55-65° C. (e.g., 60° C.). The sample is then be packed into a stainless steel holder with a well of about 1-2 cm wide by 3-5 cm long by 3-5 mm deep, after which the holder is loaded into a suitable diffractometer (e.g., X'PERT MPD POWDER diffractometer, PANalytical B.V., The Netherlands) set in reflection mode to measure the X-ray diffraction pattern of the sample. The X-ray source is a Cu X-ray tube line source with an optical focusing mirror and a ˜ 1/16° narrowing slit. X-rays are detected with a 1-D detector and an anti-scatter slit set at ˜⅛°. Data are collected in the range of about 4 to 60 degrees of two-theta at about 0.1 degrees per step. The resulting X-ray pattern is then analyzed by subtracting a linear baseline from about 7.2 to 30.5 degrees, subtracting the XRD pattern of a known amorphous alpha-1,3-glucan sample that has been scaled to fit the data, and then fitting the remaining crystal peaks in that range with a series of Gaussian curves corresponding to known dehydrated alpha-1,3-glucan crystal reflections. The area corresponding to the crystal peaks is then divided by the total area under the baseline-subtracted curve to yield a crystallinity index.

In some aspects: about, or at least about, 10, 20, 30, 40, 50, 60, 65, 70, 75, 80, 81, 82, 83, 84, 85, 86, 87, 88, 89, 90, 91, 92, 93, 94, 95, 96, 97, 98, 99, 60-85, 60-80, 60-75, 60-70, 65-85, 65-80, 65-75, 65-70, 70-85, 70-80, or 70-75 wt % of particles of insoluble alpha-glucan having any of the foregoing degrees of crystallinity can be in the form of plates, before being oxidized (and optionally after being oxidized). Such plates can be visually appreciated when viewed by electron microscopy such as TEM or SEM, for example. Typically, the balance of particles of insoluble alpha-glucan are of non-plate form.

In some aspects, the balance of the particles that are of non-plate form can be characterized as being fibrillar and/or striated in appearance. In some aspects, about, or at least about, 65%, 70%, 75%, 80%, 85%, 90%, 95%, 65-95%, 70-95%, 75-95%, 80-95%, 85-95%, 65-90%, 70-90%, 75-90%, 80-90%, 85-90%, 65-85%, 70-85%, 75-85%, or 80-85% by weight of insoluble alpha-glucan particles, before being oxidized (and optionally after being oxidized), have a diameter of less than about 1.0 micron. In some aspects, about 40-60%, 40-55%, 45-60%, 45-55%, 47-53%, 48-52%, 49-51%, or 50% by weight of insoluble alpha-glucan particles, before being oxidized (and optionally after being oxidized), have a diameter of about, or less than about, 1.0, 0.9, 0.8, 0.7, 0.6, 0.5, 0.4, 0.35, 0.34, 0.32, 0.30, 0.28, 0.26, 0.25, 0.24, 0.23, 0.22, 0.21, 0.20, 0.19, 0.18, 0.17, 0.16, 0.15, 0.14, 0.13, 0.12, 0.11, 0.10, 0.10-1.0, 0.10-0.80, 0.10-0.60, 0.10-0.40, 0.10-0.35, 0.10-0.30, 0.10-0.25, 0.10-0.20, 0.15-0.35, 0.15-0.30, 0.15-0.25, or 0.15-0.20 micron. In some aspects, about 40-60%, 40-55%, 45-60%, 45-55%, 47-53%, 48-52%, 49-51%, or 50% by weight of insoluble alpha-glucan particles, before being oxidized (and optionally after being oxidized), are aggregates of the foregoing smaller diameter particles, and have a diameter of about, less than about, or at least about, 10, 25, 50, 100, 150, 200, 250, 300, 350, 400, 450, 500, 550, 600, 10-600, 10-550, 10-500, 50-600, 50-550, 50-500, 100-600, 100-550, 100-500, 150-600, 150-550, 150-500, 200-600, 200-550, 200-500, 250-600, 250-550, or 250-500 microns. Alpha-glucan particles having any of the foregoing degrees of crystallinity can have a thickness of about 0.010, 0.015, 0.020, 0.025, 0.030, or 0.010-0.030 micron, for example; such a thickness can optionally be in conjunction with any of the foregoing diameter aspects. The foregoing particle size and/or distributions for crystalline particles herein can be as measured for particles comprised in an aqueous dispersion, and/or as measured using a light scatter technique, for example.

Insoluble alpha-glucan in the form of particles having a degree of crystallinity of at least about 0.65 can be produced, for example, by a method comprising the following steps: (a) providing insoluble alpha-glucan (precursor) as produced in an enzymatic reaction comprising at least water, sucrose and a glucosyltransferase enzyme that synthesizes the insoluble alpha-glucan, wherein the insoluble alpha-glucan has a DPw or DPn of at least about, or over about, 100, 150, or 200, and at least 50% of its glycosidic linkages are alpha-1,3 glycosidic linkages; (b) hydrolyzing the insoluble alpha-glucan (precursor) to insoluble alpha-glucan particles with a DPw or DPn, for example, of about 10 to 100 (e.g., any DPw or DPn value herein falling in this range), wherein the hydrolyzing is performed under aqueous conditions at a pH of 2.0 or less, and (c) optionally isolating the insoluble alpha-glucan particles produced in step (b). Step (b) of this method can optionally be characterized as an “acid hydrolysis” method or reaction. Insoluble alpha-glucan precursor herein for entry into acid hydrolysis is itself insoluble alpha-glucan, but has a molecular weight that is greater than that of the insoluble alpha-glucan produced by the hydrolysis method. An insoluble alpha-glucan precursor can have a glycosidic linkage profile as disclosed above (e.g., at least about 50%, 60%, 70%, 80%, 90%, 95%, 99%, 99.5%, or 100% alpha-1,3 glycosidic linkages) and a DPw or DPn of about, at least about, or over about, 200 (e.g., any such DPw or DPn as disclosed above). An acid hydrolysis herein can be performed as described in the Examples below, for example.

Insoluble alpha-glucan of the present disclosure, before being oxidized (and optionally after being oxidized), in some alternative aspects of a composition comprising a rubber component does not necessarily have features ii and/or iii (above). Thus, insoluble alpha-glucan does not necessarily have a DPw of about 15 to about 100, and/or a degree of crystallinity of at least 0.65, for example. Insoluble alpha-glucan in such alternative aspects can be any as disclosed herein, for example (e.g., having at least 50% alpha-1,3 linkages; having a DPw of about, or at least about, 100, 200, 300, 400, 500, 600, 700, 800, 900, 1000, 1100, 1200, 1300, 1400; and/or having a degree of crystallinity less than 0.65) (e.g., can be an insoluble alpha-glucan precursor herein used to prepare an insoluble alpha-glucan with features i-iii).

Insoluble alpha-glucan of the present disclosure can be in the form of fibrids in some alternative aspects (e.g., such glucan does not necessarily have a degree of crystallinity as disclosed), before being oxidized (and optionally after being oxidized). The alpha-glucan of fibrids can have a linkage profile and/or molecular weight as disclosed above, for example. Alpha-glucan fibrids herein can be as disclosed and/or produced in U.S. Pat. Appl. Publ. No. 201810119357, for example, which is incorporated herein by reference. Fibrids herein typically comprise insoluble alpha-glucan as disclosed herein, which is non-derivatized. However, in some aspects, fibrids can comprise an insoluble, charged (e.g., cationic or anionic) derivative (e.g., ether) of an alpha-glucan as disclosed herein. The DoS of such a derivative typically is less than about 0.3, 0.25, 0.2, 0.15, 0.1, or 0.05. In some aspects in which fibrids are used in a composition, the composition comprises a rubber component, or alternatively, the composition can be any composition (i.e., the composition does not necessarily comprise a rubber component).

In some alternative aspects, a composition comprising oxidized insoluble alpha-glucan of the present disclosure (e.g., having features i-iii above, before being oxidized and optionally after being oxidized) can be any composition (i.e., the composition does not necessarily comprise a rubber component). Thus, some aspects of the present disclosure concern a composition comprising at least oxidized insoluble alpha-glucan, wherein the oxidized insoluble alpha-glucan is produced by contacting an insoluble alpha-glucan under aqueous conditions with at least one agent that is capable of oxidizing the insoluble alpha-glucan, wherein (i) at least about 50% of the glycosidic linkages of the insoluble alpha-glucan are alpha-1,3 glycosidic linkages, (ii) the insoluble alpha-glucan has a weight-average degree of polymerization (DPw) of about 10 (or 15) to 100, and (iii) the insoluble alpha-glucan is in the form of particles having a degree of crystallinity of at least about 0.65.

Insoluble alpha-glucan of the presently disclosed compositions is oxidized. Such oxidized insoluble alpha-glucan can be produced by contacting an insoluble alpha-glucan as disclosed herein under aqueous conditions with at least one agent that is capable of oxidizing the insoluble alpha-glucan. Examples of an agent herein (oxidation agent) for oxidizing an insoluble alpha-glucan include N-oxoammonium salts, periodate compounds, peroxide compounds, NO₂, N₂04, and/or ozone. Also for example, an oxidized an insoluble alpha-glucan as disclosed herein can be prepared via application of an oxidation process as disclosed in Canadian Patent Publ. Nos. 2028284 or 2038640, U.S. Pat. Nos. 4,985,553, 2,894,945, 5,747,658, or 7595392, or U.S. Pat. Appl. Publ. Nos. 2015/0259439, 2018/0022834, or 2018/0079832, all of which are incorporated herein by reference.

An oxidation agent in some aspects for oxidizing an insoluble alpha-glucan herein can include one or more N-oxoammonium salts, such as those disclosed in U.S. Pat. Appl. Publ. Nos. 2015/0259439, 2018/0022834, or 2018/0079832 (ibid.). An N-oxoammonium salt herein has the following structure:

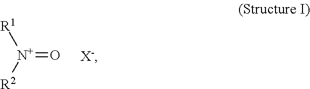

where R¹ and R² each represent the same or different organic groups (e.g., a linear or branched carbon chain), and X⁻ is a counterion. Alternatively, R¹ and R² can each be part of the same group bound to the N⁺, in which case N⁺is part of a ring structure (i.e., a cyclic N-oxoammonium salt). A cyclic N-oxoammonium salt useful herein has the following structure:

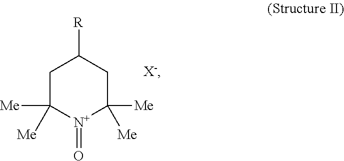

where each Me represents a methyl group, X− is a counterion, and R is a hydrogen (H), acetamido group, hydroxyl (—OH), amino (—NH₂), carboxyl (—COOH), methoxy (—OCH₃), cyano (—CN), oxo (═O), phosphonooxy [—O—PO(OH)₂], acetoxy (—O—CO—CH₃), benzoyloxy, acetamino, maleimido, or isothiocyanato group. It would be understood that where R in Structure II is an H, the cyclic N-oxoammonium salt is TEMPO salt. Examples of Structure 11 in which R is a moiety other than an H represent TEMPO salt that is substituted at carbon position 4 (where the N⁺ in Structure II is position 1 in the ring). For example, where R is an acetamido group (—NH—CO—CH₃), the cyclic N-oxoammonium salt of Structure II is 4-acetamido-TEMPO salt. Thus, for example, an N-oxoammonium salt herein can be TEMPO salt having a substitution at carbon position 4. TEMPO salt, 4-acetamido-TEMPO salt, and/or any other cyclic N-oxoammonium salt herein (e.g., Structure I i), can be used to oxidize an insoluble alpha-glucan as disclosed.

An N-oxoammonium salt herein (e.g., TEMPO salt, 4-acetamido-TEMPO salt) can be provided in some aspects by oxidizing an N-oxoammonium in aqueous conditions in which it is intended to have the N-oxoammonium salt contact (and oxidize) an insoluble alpha-glucan. Examples of an N-oxoammonium herein have the following structure:

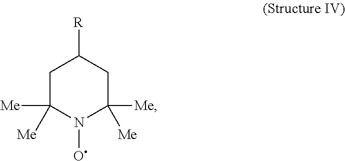

where each Me represents a methyl group and R is a hydrogen (H) (i.e., Structure IV is TEMPO), acetamido group (—NH—CO—CH₃) (i.e., Structure IV is 4-acetamido-TEMPO), hydroxyl (—OH), amino (—NH₂), carboxyl (—COOH), methoxy (—OCH₃), cyano (—CN), oxo (═O), phosphonooxy [—O—PO(OH)₂], acetoxy (—O—CO—CH₃), benzoyloxy, acetamino, maleimido, or isothiocyanato group. Each of these agents can be converted to its corresponding oxoammonium salt, as represented by Structure II, by contacting it with one or more oxidation agents (oxidants) under aqueous conditions. Thus, structure IV can also be considered as a precursor of an N-oxoammonium salt herein. TEMPO and its derivatives, such as above (e.g., 4-acetamido-TEMPO), are examples of cyclic nitroxyl compounds. Thus, a cyclic nitroxyl compound can be used to provide an N-oxoammonium salt herein, for example.

An N-oxoammonium agent can be oxidized under aqueous conditions herein to its corresponding N-oxoammonium salt by contacting the agent with one or more other oxidation agents (oxidants). This contacting can be performed, for example, in the same aqueous conditions in which an insoluble alpha-glucan is intended to be contacted with an N-oxoammonium salt. In some aspects, a reaction herein for oxidizing an insoluble alpha-glucan can initially be prepared to comprise, under aqueous conditions, at least an insoluble alpha-glucan, an N-oxoammonium agent, and one or more oxidants. The oxidant(s) can convert the N-oxoammonium agent to its corresponding N-oxoammonium salt, which in turn can oxidize the insoluble alpha-glucan.

Examples of oxidants that may be used to convert an N-oxoammonium agent herein to its corresponding N-oxoammonium salt such as TEMPO salt include one or more of a halite (e.g., a chlorite, such as sodium chlorite [NaClO₂]) or a hypohalite (e.g., a hypochlorite, such as sodium hypochlorite [NaClO]). Additional examples of oxidants that can be used to convert an N-oxoammonium agent to its corresponding N-oxoammonium salt include one or more of a halide salt such as KCl, KBr, NaCl, NaBr, or Nal; a hypohalite such as NaOBr; metals such as Fe(III), Mn(II), Mn(II), or Cu(II); KMnO₄; Mn(OAc)₃; Mn₂O₃; MnO₂; Mn(NO₃)₂; MgCl₂; Mg(OAc)₂; Cu(NO₃)₂; iodobenzene diacetate [Phl(OAc)₂]; Ca(CIO)₂; t-BuOCl; CuCl—O₂; NaBrO₂; Cl₂; Br₂; NO₂; N₂O₄; and trichloroisocyan uric acid. For example, a hypochlorite such as NaClO and a halide salt such as NaBr can be used together in combination with an N-oxoammonium agent such as TEMPO in an oxidation reaction as presently disclosed.

An oxidation agent in some aspects for oxidizing an insoluble alpha-glucan herein can include one or more periodate compounds. A periodate compound can be a metal periodate (e.g., sodium periodate or potassium periodate), for example. A periodate compound can be a metaperiodate (e.g., NalO₄) or an orthoperiodate in some aspects. Conditions herein for oxidizing an insoluble alpha-glucan with a periodate compound can, for example, follow those conditions as disclosed in U.S. Pat. Nos. 3,086,969, 6,800,753, 5,747,658, or 6635755, or U.S. Pat. Appl. Publ. Nos. 2015/0259439, 2018/0022834, or 2018/0079832, which are each incorporated herein by reference. Typically, an oxidation reaction employing periodate comprises providing an insoluble alpha-glucan in an aqueous periodate solution. The concentration of a periodate in a reaction can be about 1, 2, 3, 4, 5, 6, 7, 8, 9, or 10 wt %, for example. The temperature of a reaction herein comprising a periodate can be between about 18° C. to about 40° C. (e.g., room temperature), for example. In some aspects, a reaction comprising a periodate can proceed for about 1-72 hours (e.g., −5 hours or ˜48 hours).

In some aspects, an oxidized insoluble alpha-glucan can be produced by first contacting an insoluble alpha-glucan with a periodate compound, followed by contacting the periodate-oxidized alpha-glucan with an N-oxoammonium salt. Such a sequential oxidation treatment can follow any of the processes disclosed in U.S. Pat. Appl. Publ. Nos. 2015/0259439, 2018/0022834, or 2018/0079832 (ibid.), for example.

An oxidation agent in some aspects for oxidizing an insoluble alpha-glucan herein can include one or more peroxide compounds. A peroxide compound can be hydrogen peroxide, for example. In some aspects, a peroxide compound can be an inorganic peroxide compound or an organic peroxide compound. Suitable peroxide compounds herein further include perborate-monohydrate, perborate-tetrahydrate, percarbonates, alkali persulphates, persilicates, and percitrates, in which sodium or calcium is the preferred cation, as well as hydrogen peroxide adducts of urea or amine oxides, for example. In some aspects, an oxidized insoluble alpha-glucan is produced by first contacting an insoluble alpha-glucan with a peroxide compound, followed by contacting the peroxide-oxidized an alpha-glucan with an N-oxoammonium salt. The amount of peroxide in an oxidation reaction can be about 1, 2, 3, 4, 5, 6, 7, 8, 9, or 10 wt %, for example. A reaction employing a peroxide compound herein can have a neutral pH (e.g., pH 6-8) in some aspects. The temperature of a reaction comprising a peroxide can be between about 110° C. to about 140° C. (e.g., −121° C.), for example. It would be understood that achieving such elevated reaction temperatures can involve application of pressure, such as can be provided with an autoclave or other high pressure device. In some aspects, an oxidation reaction comprising a peroxide can proceed for about 30 minutes to about 120 minutes (e.g., ˜60 minutes).

Aqueous conditions are used in reactions herein for oxidizing an insoluble alpha-glucan. Aqueous conditions suitable for an oxidation reaction herein include a solution or mixture in which the solvent is about, or at least about, 60, 65, 70, 75, 80, 85, 90, 95, 96, 97, 98, 99, or 100 wt % water, for example. Aqueous conditions can comprise a buffer, for example, such as an acidic, neutral, or alkaline buffer, at a suitable concentration and selected based on the pH range provided by the buffer. Examples of buffers include citric acid, acetic acid, KH₂PO₄, CHES and borate.

Aqueous conditions herein can be acidic, having a pH of about, or less than about, 5.5, 5.0, 4.5, 4.0, 3.5, 3.0, 2.5, or 2.0, for example. Acidic conditions can be prepared by a variety of means, such as by adding acetic acid and/or an acetate salt to a solution or mixture. For example, a sodium acetate buffer (acetate buffer) (pH 4-5) (e.g., 0.2-0.3 M solution) can provide acidic conditions.

Aqueous conditions herein can be basic, having a pH of about, or more than about, 8.5, 9.0, 9.5, 10.0, 10.5, 11.0, 11.5, or 12, for example. Basic conditions can be prepared by a variety of means, such as by adding an alkaline hydroxide (e.g., sodium hydroxide) to a solution or mixture.

An insoluble alpha-glucan herein can be included in an oxidation reaction at about, or at least about, 0.1, 0.25, 0.5, 0.75, 1, 2, 3, 4, 5, 6, 7, 8, 9, 10, 11, 12, 13, 14, 15, 17.5, 20, 22.5, 25, 27.5, 30, 32.5, 35, 8-17.5, 8-15, 10-17.5, or 10-15 w1% of the reaction, for example. An insoluble alpha-glucan can be added (e.g., mixed or dissolved) into aqueous conditions before or after addition of oxidation agent(s) to the aqueous conditions. An insoluble alpha-giucan can be provided in some aspects of preparing an oxidation reaction in a dry form (e.g., powder, flakes), wet form (e.g., aqueous solution, wet cake), or any other suitable form for preparing an oxidation reaction.

An N-oxoammonium agent, such as TEMPO or 4-acetamido-TEMPO, can be included in an oxidation reaction herein at about, or at least about, 0.05, 0.075, 0.1, 0.25, 0.5, 0.75, 1, or 2 wt % of the reaction, for example. In some aspects, an N-oxoammonium agent can be added to an oxidation reaction in which insoluble alpha-glucan has already been mixed or dissolved. Such addition can be made before, after, or at the same time of, the addition of an oxidant for oxidizing the N-oxoammonium agent to an N-oxoammonium salt. An oxidant herein (e.g., sodium bromide and/or sodium hypochlorite) can be included in an oxidation reaction herein at about, or at least about, 0.1, 0.25, 0.5, 0.75, 1, 2, 3, 4, 5, 10, 15, 20, 25, 30, 35, 40, 45, 50, 2-12, 4-12, 2-10, or 4-10 wt % of the reaction, for example.

The time period for which an insoluble alpha-glucan herein is contacted with at least one oxidation agent herein under aqueous conditions can be about, or at least about, 0.5, 1, 4, 8, 12, 16, 20, 24, 28, 32, 36, 40, 44, 48, 72, or 96 hours (or any integer value between 1 to 96 hours), for example. A reaction can be maintained for about 0.5-5 hours (e.g., −1 hour), 2-5, 2-4, 2-3, or 24-96 hours (e.g., −48 hours) in some aspects. The period of time for contacting an insoluble alpha-glucan with at least one oxidation agent under aqueous conditions can be measured, for example, from the point of time after each reaction component has been dissolved and/or mixed in the aqueous conditions.

The temperature of aqueous conditions of an oxidation reaction herein can be about 18° C. to about 40° C. (or any integer value between 18 to 40° C.) in some aspects (e.g., when employing a periodate and/or N-oxoammonium salt). Aqueous conditions in some aspects can be maintained at a temperature of about 20-25° C. The temperature of aqueous conditions can be maintained from the time in which each reaction component has been dissolved and/or mixed under the aqueous conditions, until the reaction is completed.

Upon completion of an oxidation reaction in which acidic or basic aqueous conditions are used, the pH of the reaction can optionally be neutralized. Neutralization of an acidic reaction can be performed using one or more bases (e.g., an alkali hydroxide such as sodium hydroxide). Neutralization of a basic reaction can be performed using one or more acids (e.g., an inorganic acid such as hydrochloric acid). The term “neutral pH” as used herein, refers to a pH that is neither substantially acidic or basic (e.g., a pH of about 6-8, or about 6.0, 6.2, 6.4, 6.6, 6.8, 7.0, 7.2, 7.4, 7.6, 7.8, or 8.0).

In some aspects, an oxidation reaction can be performed with an insoluble alpha-glucan herein comprising conditions (e.g., oxidation agents, reactant concentrations, solvent, temperature, time) that are the same as those disclosed in Example 1 below, or comprising conditions (e.g., reactant concentrations, solvent, temperature, time) that are within about 20%, 15%, 10%, 5%, 2.5%, or 1% of those disclosed in Example 1.

The present disclosure also concerns a method of producing an oxidized insoluble crystalline alpha-glucan. Such a method typically comprises: (a) contacting an insoluble crystalline alpha-glucan herein (e.g., having features i-iii above) under aqueous conditions with at least one agent that is capable of oxidizing the insoluble crystalline alpha-glucan, thereby producing an oxidized insoluble crystalline alpha-glucan; and (b) optionally isolating the oxidized insoluble crystalline alpha-glucan. Any of the features described above regarding oxidizing an insoluble alpha-glucan can be applied accordingly in this oxidation method (i.e., in step [a]).

An oxidized insoluble crystalline alpha-glucan produced in an oxidation reaction herein can optionally be isolated. Since the oxidized product is aqueous insoluble, the completed reaction can optionally be characterized as a slurry or dispersion. The insoluble product can optionally be isolated using a filtration funnel, centrifuge, press filter, or any other method or equipment that allows for removal of liquids from solids. The isolated product can be dried, such as by vacuum drying, air drying, or freeze drying. An oxidized insoluble crystalline alpha-glucan product herein can optionally be washed, after separation (above) or drying, one or more times with a liquid that does not readily dissolve the compound (e.g., water or aqueous solution of pH 4-9). An aqueous solution for washing can optionally comprise an alcohol (e.g., methanol or ethanol).

An oxidized insoluble crystalline alpha-glucan produced in an oxidation reaction in some aspects is not isolated. For example, a completed oxidation reaction (slurry/dispersion) can be directly entered into a process herein for producing a rubber composition: typically, a completed oxidation reaction is neutralized (above) prior to using it in rubber production.

A composition comprises a rubber component in some aspects of the present disclosure. Such a composition can optionally be referred to as a rubber composition. A rubber composition herein typically comprises at least a rubber component, filler, and various other ingredients.

Suitable rubber components include, for example, one or more diene-based sulfur-vulcanizable elastomers having a glass transition temperature (Tg) below −30° C., as determined, for example, by dynamic mechanical analysis. In some aspects, a rubber component can comprise one or more suitable elastomers, such as natural rubber, synthetic polyisoprene, polybutadiene rubber, styrene/butadiene copolymer rubber (e.g., prepared by aqueous emulsion or organic solvent polymerization), ethylene propylene diene monomer rubber, hydrogenated nitrile butadiene rubber, neoprene, styrene/isoprene/butadiene terpolymer rubber, butadiene/acrylonitrile rubber, polyisoprene rubber, isoprene/butadiene copolymer rubber, nitrile rubber, ethylene-acrylic rubber, butyl and halobutyl rubber, chlorosulfonated polyethylene, fluoroelastomer, hydrocarbon rubber, polybutadiene, or silicone rubber. As used herein, the term “neoprene” is synonymous with polychloroprene and refers to synthetic rubber produced by polymerization of chloroprene, including sulfur-modified chloroprene. In some aspects, a rubber component comprises one or more of natural rubber, synthetic polyisoprene, styrene butadiene copolymer rubber, ethylene propylene diene monomer rubber, hydrogenated nitrile rubber, polybutadiene, silicone rubber, or neoprene.

A rubber composition herein can optionally comprise a reinforcing filler (optionally in addition to an oxidized insoluble alpha-glucan herein). A filler can comprise one or more of a silica, carbon black, oxide (e.g., titanium oxide), silicate (e.g., aluminum silicate), carbonate (e.g., calcium carbonate) clay, or talc, for example. Silica in some aspects can be synthetic precipitated silica or fumed silica. Representative of such silica, for example, is silica from PPG Industries under the Hi-Sil trademark; silica from Rhodia under the Zeosil trademark; silica from Degussa AG with designation VN2 or VN3, and silica from AKZO Chemie, for example. In some aspects, a rubber composition comprises a filler in an amount of about, or at least about, 1, 2, 3, 4, 5, 6, 7, 8, 9, 10, 11, 12, 13, 14, 15, 16, 17, 18, 19, 20, 21, 22, 23, 24, 25, 1-15, 1-20, 1-25, 5-15, 5-20, 5-25, 10-15, 10-20, 10-25, 15-20, 15-25, or 20-25 phr (parts by weight per 100 parts by weight of the rubber component). Yet, in some aspects, a rubber composition comprises a filler in an amount of about, or at least about, 25, 30, 35, 40, 45, 50, 55, 60, 65, 70, 75, 80, 85, 90, 95, 100, 110, 120, 130, 140, 150, 50-75, 50-100, 50-125, 50-150, 75-100, 75-125, 75-150, 100-125, 100-150, or 125-150 phr. Any of these phr values can be ascribed to one filler or a combination of fillers (e.g., silica and/o carbon black). A rubber composition in some aspects does not comprise silica and/or carbon black.

A rubber composition as presently disclosed comprises oxidized insoluble alpha-glucan herein. In some aspects, the amount of the oxidized insoluble alpha-glucan in terms of phr can be any phr value as disclosed above for a filler.

In some aspects, a rubber composition comprises one or more of a filler, anti-degradant (e.g., anti-oxidant and/or anti-ozonant), processing aid, compatibilizer, bonding agent, tackifier, curing agent, or accelerator.

In some aspects, a rubber composition comprises a silane coupling agent. A silane coupling agent can help bond a filler and/or oxidized insoluble alpha-glucan herein with a rubber component. Typically, a silane coupling agent comprises an organic silane compound having an organic moiety that is capable of reacting with a polymer. Examples of such an organic moiety include a sulfide, amino, mercapto, vinyl, methacryl, or epoxy group, and a halogen, an alkoxy group or the like. Optional silane coupling agents herein include bis(3-triethoxysilylpropyl)tetrasulfide, bis(3-triethoxysilylpropyl)disulfide, bis(2-triethoxysilylethyl)tetrasulfide, 3-mercaptopropyl trimethoxysilane, 3-mercaptopropyl triethoxysilane, 3-nitropropyl trimethoxysilane and 3-aminopropyl triethoxysilane. The amount of silane coupling agent used in a rubber composition herein can be in the range of 2-25, 2-15, 5-25, or 5-15 phr, for example.

In some aspects, a rubber composition comprises one, two, three, or more polyetheramines. Suitable polyetheramines herein include, for example, monoamines, diamines, and triamines having polyether backbones. The polyether backbone of a polyetheramine can be based on, for example, ethylene oxide, propylene oxide, a mixture of ethylene oxide and propylene oxide, poly(tetramethylene ether glycol, or poly(tetramethylene ether glycol)/(polypropylene glycol) copolymers. A polyetheramine can have a molecular weight of about 200 g/mole to about 5000 g/mole, or higher, for instance. A polyetheramine obtained commercially, for example (e.g., JEFFAMINE@ product line from Huntsman). A rubber composition can comprise a polyetheramine in an amount of about, or at least about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 1-15, 1-20, 1-25, 1-30, 5-15, 5-20, 5-25, 5-30, 10-15, 10-20, 10-25, 10-30, 15-20, 15-25, 15-30, 20-25, or 30-30 phr (parts by weight per 100 parts by weight of the rubber component), for example. A rubber composition does not comprise a polyetheramine in some aspects. In some aspects, a rubber composition comprises a polyetheramine and a silane coupling agent, while in some other aspects a rubber composition comprises a polyetheramine and no silane coupling agent.

A rubber composition can optionally comprise at least oxidized insoluble alpha-glucan as presently disclosed and additional ingredients/components as listed in Table 1 (Example 1) below. The phr of each ingredient/component can be within about 20%, 15%, 10%, 5%, 2.5%, or 1% of, or about the same as, those listed in Table 1, for example.

A rubber composition as disclosed herein can be compounded by methods generally known in the rubber compounding art. In some aspects, a rubber composition herein can be prepared by a method/process comprising the steps of:
(a) forming a first mixture comprising a oxidized insoluble alpha-glucan herein (e.g., oxidized crystalline insoluble alpha-glucan) (e.g., provided as an aqueous dispersion or wet cake herein) and a rubber component, wherein the first mixture is free of sulfur, accelerators, and curatives;
(b) mixing the first mixture in at least one non-productive stage at a temperature of about 80° C. to about 180° C. to produce a second mixture;
(c) adding sulfur, an accelerator, and/or a curative to the second mixture;
(d) mixing the material provided in step (c) at a temperature of about 80° C. to about 125° C.; and
e) optionally, homogenizing the material provided in step (d).

Step (a) of forming a first mixture can be performed by combining the ingredients in any order. The ingredients can be added sequentially, in portions, or all at once. Step (b) can be performed at a temperature of about 80° C. to about 180° C., for example from about 80° C. to about 160° C. Step (d) can be performed at a temperature of about 80° C. to about 125° C., for example from about 80 0° C. to about 115° C., or from about 85 0° C. to about 100° C. Concomitant with the mixing of step (b) in some aspects is a step of removing water, the water typically having been present with the oxidized insoluble alpha-glucan used in step (a).

Yet, in some aspects, a rubber composition can be produced in a method/process comprising:
(a) providing an aqueous dispersion (or other aqueous composition herein) comprising a mixture oxidized insoluble alpha-glucan herein and a rubber component,
(b) coagulating the dispersion/mixture to produce a coagulated mass, and
(c) optionally drying the coagulated mass.

These steps (a-b, or a-c) result in what can optionally be characterized as a rubber masterbatch; steps a-b or a-c can thus optionally be characterized as a method of producing a rubber masterbatch. Such a masterbatch can be entered into compounding as disclosed above, and/or by a step (optionally termed “step (d)”) of compounding the coagulated mass of step (b) or (c) (i.e., masterbatch) with at least one rubber additive, optionally wherein the rubber additive is selected from a filler, anti-oxidant, anti-ozonant, processing aid, compatibilizer, bonding agent, tackifier, curing agent, accelerator, or coupling agent.

In some aspects, forming a rubber masterbatch and/or compounding can be performed with conditions (e.g., mixing parameters, component concentrations, temperature, time) that are the same as those disclosed above or in Example 1 below, or comprising conditions that are within about 20%, 15%, 10%, 5%, 2.5%, or 1% of those disclosed above or in Example 1.

Some aspects herein concern a composition comprising oxidized crystalline insoluble alpha-glucan as presently disclosed (a rubber component may, or may not be, present in such a composition). For example, a composition herein can comprise oxidized crystalline insoluble alpha-glucan and at least one additive. An additive in such compositions can optionally be referred to as a second ingredient or second component, for example. An additive in typical aspects does not chemically react with oxidized crystalline insoluble alpha-glucan and so does not chemically modify or derivatize it in any way that results in a compound that is different from the oxidized crystalline insoluble alpha-glucan (e.g., such an additive does not serve to substitute any hydrogens of glucose monomeric unit hydroxyl groups of the oxidized crystalline insoluble alpha-glucan; such an additive does not change the molecular formula of the oxidized crystalline insoluble alpha-glucan). There can be one, two, three, four, or more additives in some aspects. An additive can be aqueous-soluble or aqueous-insoluble.

A composition as presently disclosed comprising oxidized crystalline insoluble alpha-glucan and an additive can be, for example, in the form of particles (typically insoluble particles) comprising these components. Such a composition can comprise particles of the insoluble alpha-glucan coated by the additive, for example.

A composition as presently disclosed comprising oxidized crystalline insoluble alpha-glucan and an additive can comprise about 0.1 to about 200 wt % of one or more additives, wherein this wt % is based on the weight of the one or more oxidized crystalline insoluble alpha-glucans in the composition. In some aspects, a composition comprises about 0.1, 1, 2, 3, 4, 5, 6, 7, 8, 9, 10, 11, 12, 13, 14, 15, 16, 17, 18, 19, 20, 25, 30, 35, 40, 45, 50, 75, 100, 125, 150, 175, 200, 1-200, 1-175, 1-150, 1-125, 25-200, 25-175, 25-150, 25-125, 50-200, 50-175, 50-150, 50-125, 75-200, 75-175, 75-150, 75-125, 100-200, 100-175, 100-150, 100-125, 0.1-50, 1-30, 1-25, 1-20, 1-15, 1-10, 3-30, 3-25, 3-20, 3-15, 3-10, 10-30, 10-25, 10-20, or 10-15 wt % of one or more additives, wherein this wt % is based on the weight of the one or more oxidized crystalline insoluble alpha-glucans in the composition.

An additive of a composition herein comprising oxidized crystalline insoluble alpha-glucan and an additive can be any compound of the present disclosure. While water can optionally be present in such a composition, there typically is at least one additive present that is not water. In some aspects, an additive comprises or consists of a non-aqueous liquid and/or a hydrophobic or non-polar liquid or composition. A non-aqueous liquid can be polar or non-polar (apolar), for example. An additive in some aspects can comprise or consist of a solid material; such an additive can optionally be in an aqueous liquid or non-aqueous liquid. An additive can have neutral, negative (anionic), or positive (cationic) charge, for example. An additive can be any ingredient/component of a personal care product, pharmaceutical product, household care product, industrial product, ingestible product, film/coating, composite, latex/dispersion/emulsion, encapsulant, detergent composition (e.g., fabric care, dish care), oral care, or builder composition, for example.

Merely as examples, an additive herein can be an oil such as mineral oil, silicone oil (e.g., dimethicone/polydimethylsiloxane, hexamethyldisiloxane), paraffin oil, or plant/vegetable oil (e.g., linseed oil, soybean oil, palm oil, coconut oil, canola oil, corn oil, sunflower oil, grape seed oil, cocoa butter, olive oil, rice bran oil, rapeseed oil, peanut oil, sesame oil, cottonseed oil, palm kernel oil); shortening (e.g., vegetable shortening); lipid; fat (e.g., lard, tallow, animal fat); glyceride (e.g., tri-, di- and/or mono-glyceride; e.g., caprylic/capric triglyceride); glycerol (or other polyol such as low molecular weight polyol); fatty acid; fatty aldehyde, fatty alcohol, fatty acid ester (e.g., sorbitan oleate); fatty acid amide; wax (e.g., paraffin wax, carnauba wax); phospholipid; sterol; alkane; alkene/olefin; petrolatum (i.e., petroleum jelly); grease; anionic detergent (e.g., lauryl sulfate, alkylbenzene sulfonate); cationic detergent; non-ionic or zwitterionic detergent (e.g., polyoxyethylene-based detergent such as Tween or Triton [ethoxylates], glycoside-based detergents such as octyl thioglucoside maltoside. CHAPS); or any epoxidized versions of these; or any similar compound such as disclosed in U.S. Patent Appl. Publ. Nos. 2009/0093543 (e.g., Table 2 therein) or 2019/0144897, which are incorporated herein by reference. Merely as examples, an additive herein can be a sugar alcohol (e.g., mannitol, sorbitol, xylitol, lactitol, isomalt, maltitol, hydrogenated starch hydrolysate), polymeric polyol (e.g., polyether polyol, polyester polyol, polyethylene glycol, polyvinyl alcohol), aprotic solvent (e.g., a polar aprotic solvent such as acetone or propylene carbonate), protic solvent (e.g., isopropanol, ethanol, methanol), hardener (e.g., active halogen compound, vinylsulfone, epoxy), resin (typically uncured) (e.g., synthetic resin such as epoxy or acetal resin; natural resin such as plant resin [e.g., pine resin], insect resin [e.g., shellac], or bitumin), or propanediol (1,3-propanediol). Merely as examples, an additive herein can be a fragrance/scent (e.g., hydrophobic aroma compound, or any as disclosed in U.S. Pat. No. 7,196,049, which is incorporated herein by reference), ingestible product, food, beverage, flavor (e.g., any as disclosed in U.S. Pat. No. 7,022,352, which is incorporated herein by reference), or hydrophobic flavorant or nutrient, or dye (e.g., oil-soluble dye such as Sudan red). Merely as examples, an additive herein can be polyurethane, polyvinyl acetate, poly acrylate (i.e., acrylic), poly lactic acid, polyvinylamine, polycarboxylate, a polysaccharide (e.g., glucan such as cellulose, starch, beta-1, 3-glucan; fructan; xylan; arabinan; mannan; galactan) other than an insoluble alpha-glucan having at least 50% alpha-1,3 glycosidic linkages, gelatin, melamine, inorganic filler material (e.g., carbon black, a silicate such as sodium silicate, talk, chalk, a clay such as bentonite clay, or a carbonate such as calcium carbonate, calcium-magnesium carbonate, sodium percarbonate, sodium carbonate, sodium bicarbonate, ammonium bicarbonate, barium carbonate, magnesium carbonate, potassium carbonate, or iron[ll]carbonate), penetrant (e.g., 1,2-propanediol, triethyleneglycol butyl ether, 2-pyrrolidone), biocide (e.g., metaborate, thiocyanate, sodium benzoate, benzisothiaolin-3-one), yellowing inhibitor (e.g., sodium hydroxymethyl sulfonate, sodium p-toluenesulfonate), ultraviolet absorbers (e.g., benzotriazole compound), antioxidant (e.g., sterically hindered phenol compound), water-resistance agent (e.g., ketone resin, anionic latex, glyoxal), or binder (e.g., polyvinyl alcohol, polyvinyl acetate, partially saponified polyvinyl acetate, silanol-modified polyvinyl alcohol, polyurethane, starch, corn dextrin, carboxymethyl cellulose, cellulose ether, hydroxyethyl cellulose, hydroxypropyl cellulose, ethylhydroxyethyl cellulose, methyl cellulose, alginate, sodium alginate, xanthan, carrageenan, casein, soy protein, guar gum, styrene butadiene latex, styrene acrylate latex). Yet, in some aspects, an additive herein can be characterized/categorized as follows: amphiphilic material (e.g., surfactants such as lauryl sulfate; polymeric surfactants such as polyethylene glycol or polyvinyl alcohol: particles such as silica), physically adsorbed aqueous-insoluble small molecules (e.g., mineral oil; silicone oil; natural oil such as linseed, soybean, palm, or coconut oil), physically adsorbed aqueous-insoluble polymeric molecules (e.g., polyacrylate, polyvinylacetate, poly lactic acid), physically adsorbed aqueous-miscible small molecules (e.g., protic solvents such as isopropanol, ethanol, or methanol: polar aprotic solvents such as acetone or propylene carbonate; low molecular weight polyols such as glycerol; sugar alcohols), physically adsorbed water-miscible polymeric molecules (e.g., a polyol), chemically adsorbed/reacted material (e.g., alkyl ketene dimer; an alkenyl succinic anhydride such as octenyl succinic anhydride; epoxy compounds such as epoxidized linseed oil or a di-epoxy). In some aspects, an additive can be an alkyl ketene dimer (AKD), alkenyl succinic anhydride (e.g., octenyl succinic anhydride), epoxy compound (e.g., epoxidized linseed oil or a di-epoxy), phenethyl alcohol, undecyl alcohol, or tocopherol. In some aspects, an additive comprises an oil or any other hydrophobic solvent herein in which a hydrophobic substance (e.g., any as disclosed herein such as a hydrophobic fragrance, flavor, nutrient, or dye) has been dissolved. An additive herein typically is not only a salt (salt ion) or buffer such as Nat, C1−, NaCl, phosphate, tris, or any other salt/buffer such as disclosed in U.S. Patent Appl. Publ. Nos. 2014/179913, 2016/0304629, 2016/0311935, 2015/0239995, 2018/0230241, or 2018/0237816, which are incorporated herein by reference. An additive can be any as disclosed in U.S. Patent Appl. Publ. No. 2019/0153674 (incorporated herein by reference), for example.

An additive is hydrophobic in some aspects (e.g., any of the above that are hydrophobic/apolar/non-polar). A hydrophobic additive is a liquid (e.g., at a temperature disclosed herein, e.g., 10-60, 15-60, 20-60, 25-60, 30-60, 10-55, 15-55, 20-55, 25-55, 30-55, 10-50, 15-50, 20-50, 25-50, 30-50, 10-45, 15-45, 20-45, 25-45, 3045, 10-40, 15-40, 20-40, 25-40, or 30-40° C.) and not miscible in an aqueous composition (i.e., aqueous-insoluble) (e.g., in caustic or non-caustic aqueous conditions herein), for example. A liquid hydrophobic additive can be oil, for example, such as an oil disclosed herein. In some aspects, a hydrophobic additive is a solid (e.g., at a temperature disclosed herein) and not dissolvable in an aqueous composition (e.g., caustic or non-caustic aqueous conditions herein). A solid hydrophobic additive can be wax or grease, for example. In some aspects, a solid hydrophobic additive has a melting point of about, or at least about, 45, 46, 48, 50, 52, 54, 56, 58, 60, 62, 64, 66, 68, 70, 75, 80, 85, 90, 95, 100, 45-70, 45-65, 50-70, or 50-65 °C.

A composition as presently disclosed comprising oxidized crystalline insoluble alpha-glucan herein can be an aqueous composition (e.g., dispersion such as colloidal dispersion) or a dry composition, for example (a rubber component may, or may not be, present in such a composition). In some aspects, a composition herein can comprise about, at least about, or less than about, 0.01, 0.05, 0.1, 0.2, 0.25, 0.3, 0.4, 0.5, 0.6, 0.7, 0.75, 0.8, 0.9, 1.0, 1.2, 1.25, 1.4, 1.5, 1.6, 1.75, 1.8, 2.0, 2.25, 2.5, 3.0, 3.5, 4.0, 4.5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 99.5 wt % or w/v % of oxidized crystalline insoluble alpha-glucan. A composition can comprise a range between any two of these wt % or w/v % values (e.g., 5-50, 5-45, 5-40, 5-35, 5-30, 5-25, 5-20, 5-15, or 5-10 wt % or w/v %), for example. The liquid component of an aqueous composition can be an aqueous fluid such as water or aqueous solution, for instance. The solvent of an aqueous solution typically is water, or can comprise about, or at least about, 10, 20, 30, 40, 50, 60, 70, 80, 90, 95, 98, or 99 wt % water, for example. In some aspects, a composition herein can comprise, or be in the form of, a dispersion (e.g., emulsion), wet cake or wet powder (e.g., particles of average diameter/size of about 0.1-10, 0.1-5, 1-10, 1-5, 2-10, or 2-5 millimeters [mm] having 50%-90% by weight water and 10-50% by weight solids), dry powder, extrusion, composite, film/coating, or encapsulant.

An aqueous composition herein can have a viscosity of about, at least about, or less than about, 1, 5, 10, 100, 200, 300, 400, 500, 600, 700, 1000, 2000, 3000, 4000, 5000, 6000, 7000, 8000, 9000, 10000, 15000, 1-300, 10-300, 25-300, 50-300, 1-250, 10-250, 25-250, 50-250, 1-200, 10-200, 25-200, 50-200, 1-150, 10-150, 25-150, 50-150, 1-100, 10-100, 25-100, or 50-100 centipoise (cps), for example. Viscosity can be as measured with an aqueous composition herein at any temperature between about 3° C. to about 80° C., for example (e.g., 4-30° C., 15-30° C., 15-25° C.). Viscosity typically is as measured at atmospheric pressure (about 760 torr) or a pressure that is ±10% thereof. Viscosity can be measured using a viscometer or rheometer, for example, and can optionally be as measured at a shear rate (rotational shear rate) of about 0.1, 0.5, 1.0, 5, 10, 50, 100, 500, 1000, 0.1-500, 0.1-100, 1.0-500, 1.0-1000, or 1.0-100 s−1 (1/s), for example.

The aqueous solution component of an aqueous composition in some aspects has no (detectable) dissolved sugars, or about 0.1-1.5, 0.1-1.25, 0.1-1.0, 0.1-. 75, 0.1-0.5, 0.2-0.6, 0.3-0.5, 0,2, 0.3, 0.4, 0.5, or 0.6 wt % dissolved sugars. Such dissolved sugars can include sucrose, fructose, leucrose, and/or soluble gluco-oligosaccharides, for example. The aqueous solution component of an aqueous composition in some aspects can have one or more salts/buffers (e.g., Na*, C1-, NaCl, phosphate, tris, citrate) (e.g., 0.1, 0.5, 1.0, 2.0, or 3.0 wt %), and/or a pH of about 4.0, 4.5, 5.0, 5.5, 6.0, 6.5, 7.0, 7.5, 8.0, 8.5, 9.0, 9.5, 10.0, 10.5, 4.0-10.0, 4.0-9.0, 4.0-8.0, 5.0-10.0, 5.0-9.0, 5.0-8.0, 6.0-10.0, 6.0-9.0, or 6.0-8.0, for example.

In some aspects, with an aqueous composition that is an aqueous dispersion (e.g., emulsion) of particles of oxidized crystalline insoluble alpha-glucan of the present disclosure, the particles are dispersed through about, or at least about, 30%, 40%, 50%, 60%, 70%, 80%, 85%, 90%, 95%, 98%, 99%, or 100% of the volume of the dispersion. In some aspects, such a level of dispersion (e.g., emulsion) is contemplated to be for a time (typically beginning from initial preparation of the dispersion) of about, at least about, or up to about, 0.5, 1, 2, 4, 6, 8, 10, 20, 30, 60, 90, 120, 150, 180, 210, 240, 270, 300, 330, or 360 days, or 1, 2, or 3 years.

The temperature of a composition herein can be about, or up to about, 0, 5, 10, 15, 20, 25, 30, 35, 40, 45, 50, 55, 60, 65, 70, 75, 80, 85, 90, 95, 100, 105, 110, 115, 120, 125, 130, 5-50, 20-25, 20-30, 20-40, 30-40, 40-130, 40-125, 40-120, 70-130, 70-125, 70-120, 80-130, 80-125, 80-120, 60-100, 60-90, 70-100, 70-90, 75-100, 75-90, or 75-85° C., for example.

A composition herein can, in some aspects, be non-aqueous (e.g., a dry composition). Examples of such embodiments include powders, granules, microcapsules, flakes, or any other form of particulate matter. Other examples include larger compositions such as pellets, bars, kernels, beads, tablets, sticks, or other agglomerates. A non-aqueous or dry composition typically has about, or no more than about, 12, 10, 8, 6, 5, 4, 3, 2, 1.5, 1.0, 0.5, 0.25, 0.10, 0.05, or 0.01 wt % water comprised therein. In some aspects (e.g., those directed to laundry or dish washing detergents), a dry composition herein can be provided in a sachet or pouch.

A composition herein can, in some aspects, comprise one or more salts such as a sodium salt (e.g., NaCl, Na₂SO₄). Other non-limiting examples of salts include those having (I) an aluminum, ammonium, barium, calcium, chromium (II or III), copper (I or II), iron (II or III), hydrogen, lead (II), lithium, magnesium, manganese (II or III), mercury (I or II), potassium, silver, sodium strontium, tin (II or IV), or zinc cation, and (ii) an acetate, borate, bromate, bromide, carbonate, chlorate, chloride, chlorite, chromate, cyanamide, cyanide, dichromate, dihydrogen phosphate, ferricyanide, ferrocyanide, fluoride, hydrogen carbonate, hydrogen phosphate, hydrogen sulfate, hydrogen sulfide, hydrogen sulfite, hydride, hydroxide, hypochlorite, iodate, iodide, nitrate, nitride, nitrite, oxalate, oxide, perchlorate, permanganate, peroxide, phosphate, phosphide, phosphite, silicate, stannate, stannite, sulfate, sulfide, sulfite, tartrate, or thiocyanate anion. Thus, any salt having a cation from (i) above and an anion from (ii) above can be in a composition, for example. A salt can be present in an aqueous composition herein at a wt % of about, or at least about, 0.01, 0.025, 0.05, 0.075, 0.1, 0.25, 0.5, 0.75, 1.0, 1.25, 1.5, 1.75, 2.0, 2.5, 3.0, 3.5, 0.01-3.5, 0.5-3.5, 0.5-2.5, or 0.5-1.5 wt % (such wt % values typically refer to the total concentration of one or more salts), for example.

A composition herein can optionally contain one or more enzymes (active enzymes). Examples of suitable enzymes include proteases, cellulases, hemicellulases, peroxidases, lipolytic enzymes (e.g., metallolipolytic enzymes), xylanases, lipases, phospholipases, esterases (e.g., arylesterase, polyesterase), perhydrolases, cutinases, pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, and amylases. If an enzyme(s) is included, it may be comprised in a composition herein at about 0.0001-0.1 wt % (e.g., 0.01-0.03 wt %) active enzyme (e.g., calculated as pure enzyme protein), for example. In fabric care or automatic dishwashing applications, an enzyme herein (e.g., any of the above such as cellulase, protease, amylase, and/or lipase) can be present in an aqueous composition in which a fabric or dish is treated (e.g., wash liquor, grey water) at a concentration that is minimally about 0.01-0.1 ppm total enzyme protein, or about 0.1-10 ppb total enzyme protein (e.g., less than 1 ppm), to maximally about 100, 200, 500, 1000, 2000, 3000, 4000, or 5000 ppm total enzyme protein, for example.

A composition of the present disclosure is biodegradable in some aspects. Such biodegradability can be, for example, as determined by the Carbon Dioxide Evolution Test Method (OECD Guideline 301B, incorporated herein by reference), to be about, at least about, or at most about, 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%: 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 15, 30, 45, 60, 75, or 90 days of testing. Biodegradability in some aspects can be with respect to an incumbent material such as a polyacrylate. It is contemplated that the biodegradability of a composition herein can be about, at least about, or at most about, 10%, 25%, 50%, 75%, 100%, 150%, 200%, 250%, 500%, 750%, or 1000% higher than the biodegradability of an incumbent material; such biodegradability can be as determined above, for example.

A composition as presently disclosed comprising oxidized crystalline insoluble alpha-glucan can be in the form of a household care product, personal care product, industrial product, ingestible product (e.g., food product), medical product, or pharmaceutical product, for example, such as described in any of U.S. Patent Appl. Publ. Nos. 2018/0022834, 2018/0237816, 2018/0230241, 20180079832, 2016/0311935, 201610304629, 2015/0232785, 2015/0368594, 2015/0368595, 2016/0122445, 2019/0202942, or 2019/0309096, or Int. Patent Appl. Publ. No. WO2016/133734, which are all incorporated herein by reference (a rubber component may, or may not be, present in such a composition). In some aspects, a composition can comprise at least one component/ingredient of a household care product, personal care product, industrial product, pharmaceutical product, or ingestible product (e.g., food product) as disclosed in any of the foregoing publications and/or as presently disclosed.

A composition in some aspects is believed to be useful for providing one or more of the following physical properties to a personal care product, pharmaceutical product, household product, industrial product, or ingestible product (e.g., food product): thickening, freeze/thaw stability, lubricity, moisture retention and release, texture, consistency, shape retention, emulsification, binding, suspension, dispersion, gelation, reduced mineral hardness, for example.

Personal care products herein are not particularly limited and include, for example, skin care compositions, cosmetic compositions, antifungal compositions, and antibacterial compositions. Personal care products herein may be in the form of, for example, lotions, creams, pastes, balms, ointments, pomades, gels, liquids, combinations of these and the like. The personal care products disclosed herein can include at least one active ingredient, if desired. An active ingredient is generally recognized as an ingredient that causes an intended pharmacological effect.

In some aspects, a skin care product can be applied to skin for addressing skin damage related to a lack of moisture. A skin care product may also be used to address the visual appearance of skin (e.g., reduce the appearance of flaky, cracked, and/or red skin) and/or the tactile feel of the skin (e.g., reduce roughness and/or dryness of the skin while improved the softness and subtleness of the skin). A skin care product typically may include at least one active ingredient for the treatment or prevention of skin ailments, providing a cosmetic effect, or for providing a moisturizing benefit to skin, such as zinc oxide, petrolatum, white petrolatum, mineral oil, cod liver oil, lanolin, dimethicone, hard fat, vitamin A, allantoin, calamine, kaolin, glycerin, or colloidal oatmeal, and combinations of these. A skin care product may include one or more natural moisturizing factors such as ceramides, hyaluronic acid, glycerin, squalane, amino acids, cholesterol, fatty acids, triglycerides, phospholipids, glycosphingolipids, urea, linoleic acid, glycosaminoglycans, mucopolysaccharide, sodium lactate, or sodium pyrrolidone carboxylate, for example.

Other ingredients that may be included in a skin care product include, without limitation, glycerides, apricot kernel oil, canola oil, squalane, squalene, coconut oil, corn oil, jojoba oil, jojoba wax, lecithin, olive oil, safflower oil, sesame oil, shea butter, soybean oil, sweet almond oil, sunflower oil, tea tree oil, shea butter, palm oil, cholesterol, cholesterol esters, wax esters, fatty acids, and orange oil. A skin care product can be an ointment, lotion, or sanitizer (e.g., hand sanitizer) in some aspects.

A personal care product herein can also be in the form of makeup, lipstick, mascara, rouge, foundation, blush, eyeliner, lip liner, lip gloss, other cosmetics, sunscreen, sun block, nail polish, nail conditioner, bath gel, shower gel, body wash, face wash, lip balm, skin conditioner, cold cream, moisturizer, body spray, soap, body scrub, exfoliant, astringent, scruffing lotion, depilatory, permanent waving solution, antidandruff formulation, antiperspirant composition, deodorant, shaving product, pre-shaving product, after-shaving product, cleanser, skin gel, rinse, dentifrice composition, toothpaste, or mouthwash, for example. An example of a personal care product (e.g., a cleanser, soap, scrub, cosmetic) comprises a carrier or exfoliation agent (e.g., jojoba beads [jojoba ester beads]) (e.g., about 1-10, 3-7, 4-6, or 5 wt %); such an agent may optionally be dispersed within the product.

A personal care product in some aspects can be a hair care product. Examples of hair care products herein include shampoo, hair conditioner (leave-in or rinse-out), cream rinse, hair dye, hair coloring product, hair shine product, hair serum, hair anti-frizz product, hair split-end repair product, mousse, hair spray, and styling gel. A hair care product can be in the form of a liquid, paste, gel, solid, or powder in some embodiments. A hair care product as presently disclosed typically comprises one or more of the following ingredients, which are generally used to formulate hair care products: anionic surfactants such as polyoxyethylenelauryl ether sodium sulfate; cationic surfactants such as stearyltrimethylammonium chloride and/or distearyltrimethylammonium chloride; nonionic surfactants such as glyceryl monostearate, sorbitan monopalmitate and/or polyoxyethylenecetyl ether; wetting agents such as propylene glycol, 1,3-butylene glycol, glycerin, sorbitol, pyroglutamic acid salts, amino acids and/or trimethylglycine; hydrocarbons such as liquid paraffins, petrolatum, solid paraffins, squalane and/or olefin oligomers; higher alcohols such as stearyl alcohol and/or cetyl alcohol; superfatting agents; antidandruff agents; disinfectants; anti-inflammatory agents; crude drugs; water-soluble polymers such as methyl cellulose, hydroxycellulose and/or partially deacetylated chitin; antiseptics such as paraben; ultra-violet light absorbers; pearling agents; pH adjustors; perfumes; and pigments.

A pharmaceutical product herein can be in the form of an emulsion, liquid, elixir, gel, suspension, solution, cream, or ointment, for example. Also, a pharmaceutical product herein can be in the form of any of the personal care products disclosed herein, such as an antibacterial or antifungal composition. A pharmaceutical product can further comprise one or more pharmaceutically acceptable carriers, diluents, and/or pharmaceutically acceptable salts. A composition herein can also be used in capsules, encapsulants, tablets, tablet coatings, and as an excipients for medicaments and drugs.

A composition herein can be an encapsulant, for instance. An encapsulant can be used for controlling the release of, and/or protecting, the material and/or active agent(s)/compound(s) held within the encapsulant, for instance. An encapsulant herein can encapsulate a fragrance (e.g., any as disclosed in U.S. Pat. No. 7,196,049, which is incorporated herein by reference), ingestible product (e.g., food, beverage, a flavor such as disclosed in U.S. Pat. No. 7,022,352, which is incorporated herein by reference), pharmaceutical or health product (e.g., liquid drug, prebiotic, probiotic), personal care product (e.g., toothpaste, mouth wash, face/body cream), household care product (e.g., dry or liquid detergent, bleach). Any suitable composition/product disclosed elsewhere herein, or as disclosed in U.S. Patent Appl. Publ. Nos. 2009/0209661 or 2007/0148105 (each incorporated herein by reference, e.g., consumer product) can be encapsulated, for example. In some aspects, an encapsulant herein can encapsulate a hydrophobic or non-polar composition; a hydrophobic or non-polar composition can comprise a lipid (e.g., oil, essential oil, fat, wax, free fatty acids, glycerol, phospholipids, sterols, triglycerides, diglycerides, monoglycerides), alkane, alkene/olefin, a hydrophobic aromatic or cyclic compound, a hydrophobic aroma compound, and/or a hydrophobic flavorant or nutrient, for example. An encapsulated product herein can be in a dry form in some aspects. An encapsulant in some cases can have a composition/formulation, and/or thickness, that is the same as, or similar to, that of a film or coating herein, where such film or coating is suitable for use as an encapsulant. An encapsulant can comprise about, or at least about, 50, 60, 70, 80, 90, 91, 92, 93, 94, 95, 96, 97, 98, 99, or 100 wt % of a composition herein comprising oxidized crystalline insoluble alpha-glucan, for example. This and/or other encapsulants herein can further comprise, in some aspects, polyurethane, polyvinyl acetate, poly acrylate, poly lactic acid, polysaccharide (in addition to oxidized crystalline insoluble alpha-glucan herein), gelatin, melamine, and/or formaldehyde. One or more additional additives can optionally be included that alter the mechanical, thermal, and/or degradation profile of an encapsulant herein.

In some aspects, an encapsulated composition as presently disclosed can be produced by a method comprising: (a) providing a liquid emulsion comprising at least a composition herein comprising oxidized crystalline insoluble alpha-glucan, water and a liquid/compound that is immiscible in water (e.g., any hydrophobic or non-polar substance disclosed herein), and (b) removing all or most of (88%, 90%, 95%, 98%, 99%, 99.5%, 99.9% by weight) the water from the emulsion. Such removal can comprise drying such as by freeze-drying or spray-drying. A liquid emulsion can be provided in an encapsulation method, for example, by mixing and/or homogenizing the foregoing emulsion components. In some aspects, the temperature of the mixture to be emulsified is increased to aid emulsification. For example, the temperature can be raised in order to liquify/melt a non-water component (immiscible component), such as a component that is solid at room temperature (e.g., the temperature is raised at least 1 or 2° C. above the melting point of the immiscible component), thereby providing the liquid/compound that is immiscible in water. The increased temperature of the emulsification is typically maintained until the point of entering the emulsification to the drying step. In an encapsulation method herein, it should be understood that, regarding the product of the method, the liquid/compound (or solid, as the case may be, depending on melting point) that is immiscible in water is encapsulated by a composition herein comprising oxidized crystalline insoluble alpha-glucan. In some alternative aspects of an encapsulant or encapsulation method of the present disclosure, oxidized insoluble alpha-glucan as disclosed herein with a crystallinity index of less than 0.65 can be used instead of, or in addition to, a composition comprising oxidized crystalline insoluble alpha-glucan.

A household and/or industrial product herein can be in the form of drywall tape-joint compounds; mortars; grouts; cement plasters; spray plasters; cement stucco; adhesives; pastes; wall/ceiling texturizers; binders and processing aids for tape casting, extrusion forming, injection molding and ceramics; spray adherents and suspending/dispersing aids for pesticides, herbicides, and fertilizers; fabric care products such as fabric softeners and laundry detergents; hard surface cleaners; air fresheners; polymer emulsions; latex; gels such as water-based gels; surfactant solutions; paints such as water-based paints; protective coatings; adhesives; sealants and caulks; inks such as water-based ink; metal-working fluids; films or coatings; or emulsion-based metal cleaning fluids used in electroplating, phosphatizing, galvanizing and/or general metal cleaning operations, for example. In some aspects, a composition herein is comprised in a fluid as a viscosity modifier and/or friction reducer; such uses include downhole operations/fluids (e.g., in hydraulic fracturing and enhanced oil recovery).

Examples of ingestible products herein include a food, beverage, animal feed, an animal health and/or nutrition product, and/or pharmaceutical product. The intended use of a composition as presently disclosed in an ingestible product can be to provide texture, add volume, and/or thicken, for example.

Further examples of using a composition of the present disclosure for ingestible products include use as: a bulking, binding and/or coating ingredient; a carrier for coloring agents, flavors/fragrances, and/or high intensity sweeteners; a spray drying adjunct; a bulking, bodying, dispersing and/or emulsification agent; and an ingredient for promoting moisture retention (humectant). Illustrative examples of products that can be prepared having a composition herein include food products, beverage products, pharmaceutical products, nutritional products, and sports products. Examples of beverage products herein include concentrated beverage mixes, carbonated beverages, non-carbonated beverages, fruit-flavored beverages, fruit juices, teas, coffee, milk nectars, powdered drinks, liquid concentrates, milk drinks, ready-to-drink (RTD) products, smoothies, alcoholic beverages, flavored waters and combinations thereof. Examples of food products herein include baked goods (e.g., breads), confectioneries, frozen dairy products, meats, artificial/synthetic/cultured meat, cereal products (e.g., breakfast cereals), dairy products (e.g., yogurt), condiments (e.g., mustard, ketchup, mayonnaise), snack bars, soups, dressings, mixes, prepared foods, baby foods, diet preparations, peanut butter, syrups, sweeteners, food coatings, pet food, animal feed, animal health and nutrition products, dried fruit, sauces, gravies, jams/jellies, dessert products, spreads, batters, breadings, spice mixes, frostings and the like. In some aspects, a composition herein can provide or enhance the foaming of beverages such as dairy beverages, non-dairy alternative beverages (e.g., “vegan” milk such as soy milk, almond milk, or coconut milk), dairy creamers, and/or non-dairy creamers (e.g., for a hot beverage such as coffee [e.g., cappuccino], tea [e.g., chai tea]).

A composition herein comprising oxidized crystalline insoluble alpha-glucan can be comprised in a personal care product, pharmaceutical product, household product, industrial product, or ingestible product (e.g., food product) in an amount that provides a desired degree of thickening and/or dispersion, for example. Examples of a concentration or amount of a disclosed composition in a product are any of the weight percentages provided herein.

In some aspects, an aqueous composition herein comprising oxidized crystalline insoluble alpha-glucan further comprises (e.g., is bound to) at least one cation (a rubber component may, or may not be, present in such a composition). Such binding is typically via ionic bonding. Examples of a cation include one or more hard water cations such as Ca²⁺ and/or Mg²⁺. The binding of a composition herein to a cation in an aqueous composition/system can act to soften the water (act as a builder) of the aqueous composition/system. Typically, a composition herein having this applicability comprises particles having a negative surface charge.

An aqueous composition/system in which a composition herein can bind to at least one cation can be wash liquor/grey water being used to wash dishware herein (e.g., in an automatic dishwashing machine) or fabric-containing articles herein (e.g., clothes: such as in a laundry machine), or any other aqueous composition/system to which a detergent has been added for washing and/or providing maintenance, for example; such an aqueous composition/system typically can benefit from the ability of a composition herein to prevent/reduce negative effects (e.g., scale deposition and/or scum formation) caused by the presence of one or more cations. In some aspects, an aqueous composition/system in which a composition herein can bind to at least one cation can be any system disclosed herein in which water or an aqueous solution is circulated, transited, and/or stored (a detergent does not necessarily need to be present); such a system typically can also benefit for the same reasons as disclosed above. Typically, a composition in some aspects can act as a builder/softener by sequestering/chelating and/or precipitating cations. The binding (or other interaction, whatever the case may be) between a composition herein with a cation can prevent/reduce formation (e.g., by about, or at least about 10%, 20%, 30%, 40%, 50%, 60%, 70%, or 80%, as compared to not using the composition) of undesired insoluble salts (e.g., carbonates such as CaCO₃ or MgCO₃, hydroxides such as Mg(OH)₂ or Ca(OH)₂, sulfates such a CaSO₄) and/or other insoluble compounds (e.g., calcium and/or magnesium salts of fatty acids such as stearate), and/or their deposits (e.g., scale, scum such as soap scum) that can form in aqueous systems having hard water cations. In some aspects, scale can comprise CaCO₃, MgCO₃, CaSO₄, Fe₂O₃, FeS, and/or FeS₂.

In addition to those mentioned above, some examples of aqueous systems herein that can be treated with a composition herein include those of an industrial setting. Examples of industrial settings herein include those of an energy (e.g., fossil fuel such as petroleum or natural gas), water (e.g., water treatment and/or purification, industrial water, wastewater treatment), agriculture (e.g., grain, fruits/vegetables, fishing, aquaculture, dairy, animal farming, timber, plants), chemical (e.g., pharmaceutical, chemical processing), food processing/manufacturing, mining, or transportation (e.g., fresh water and/or maritime shipping, train or truck container) industry. Further examples of aqueous systems herein that can be treated with a composition herein include those for water treatment, water storage, and/or other water-bearing system (e.g., piping/conduits, heat exchangers, condensers, filters/filtration systems, storage tanks, water cooling towers, water cooling systems/apparati, pasteurizers, boilers, sprayers, nozzles, ship hull, ballast water). Further examples of aqueous systems herein that can be treated with a composition herein include those of a medical/dental/healthcare setting (e.g., hospital, clinic, examination room, nursing home), food service setting (e.g., restaurant, commissary kitchen, cafeteria), retail setting (e.g., grocery, soft drink machine/dispenser), hospitality/travel setting (e.g., hotel/motel), sports/recreational setting (e.g., aquatics/tubs, spa), or office/home setting (e.g., bathroom, tub/shower, kitchen, appliances [e.g., laundry machine, automatic dishwashing machine, fridge, freezer], sprinkler system, home/building water piping, water storage tank, water heater). Further examples of aqueous systems herein that can be treated with a composition herein include those as disclosed in any of U.S. Patent Appl. Publ. Nos. 2013/0029884, 2005/0238729, 2010/0298275, 2016/0152495, 201310052250, 2015/009891, 2016/0152495, 2017/0044468, 201210207699, or 2020/0308592, or U.S. Pat. Nos. 4,552,591, 4,925,582, 6,478,972, 6,514,458, 6,395,189, 7,927,496, or 8784659, which are all incorporated herein by reference. In some aspects, an aqueous system that can be treated herein comprises (i) salt water such as seawater, or (ii) an aqueous solution having about 2.0, 2.25, 2.5, 2.75, 3.0, 3.25, 3.5, 3.75, 4.0, 2.5-4.0, 2.75-4.0, 3.0-4.0, 2.5-3.5, 2.75-3.5, 3.0-3.5, 3.0-4.0, or 3.0-3.5 wt % of one or a combination of salts (e.g., including at least NaCl).

A composition herein comprising oxidized crystalline insoluble alpha-glucan can be a film or coating, for example (a rubber component may, or may not be, present in such a composition). A film or coating can be a dried film or coating in some aspects, comprising less than about 3, 2, 1, 0.5, or 0.1 wt % water, for example. In some aspects, a film or coating can comprise about 20-40, 20-35, 20-30, 25-40, 25-35, or 25-30 wt % a composition herein, where the balance of material in the film or coating optionally is water, an aqueous solution, and/or a plasticizer. The amount a composition as presently disclosed in a film or coating herein can be about, or at least about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.9 wt %, for example. A film or coating herein can be produced, for example, by providing a layer of an aqueous dispersion/emulsion of particles of the disclosed composition (oxidized crystalline insoluble alpha-glucan) onto a surface/object/material, and then removing all of, or most of (_90, 95, 98, 99 wt %), the water from the dispersion/emulsion, thereby producing a film or coating. Methodology similar to, or as disclosed in, L.S. Pat. Appl. Publ. No. 2018/0258590 (incorporated herein by reference) can be used to produce a film or coating, for example.

A film or coating herein can have a thickness of about, at least about, or up to about, 0.5, 0.6, 0.7, 0.8, 0.9, 1.0, 1.1, 1.2, 1.3, 1.4, 1.5, 2, 2.5, 5, 7.5, 10, 15.5, 15, 17.5, 20, 22.5, 25, 30, 35, 40, 45, 50, 75, 100, 150, 200, 0.5-1.5, 0.8-1.5, 1.0-1.5, 0.5-1.4, 0.8-1.4, or 1.0-1.4 mil (1 mil=0.001 inch), for instance. In some aspects, such thickness is uniform, which can be characterized by having a contiguous area that (i) is at least 20%, 30%, 40%, or 50% of the total film/coating area, and (ii) has a standard deviation of thickness of less than about 0.06, 0.05, or 0.04 mil. A film or coating herein can be characterized as thin (e.g., <2 mil) in some aspects. A film herein is typically a cast film.

A film or coating herein can exhibit various degrees of transparency as desired. For example, a film/coating can be highly transparent (e.g., high light transmission, and/or low haze). Optical transparency as used herein can, for example, refer to a film or coating allowing at least about 10-99% light transmission, or at least about 50%, 60%, 70%, 80%, 90%, 95%, 96%, 97%, 98%, or 99% light transmission, and/or less than 30%, 25%, 20%, 15%, 10%, 5%, 2.5%, 2%, or 1% haze. High optical transparency can optionally refer to a film/coating having at least about 90% light transmittance and/or a haziness of less than 10%. Light transmittance of a film/coating herein can be measured following test ASTM D1746 (2009, Standard Test Method for Transparency of Plastic Sheeting, ASTM International, West Conshohocken, PA), for example, which is incorporated herein by reference. Haze of a film/coating herein can be measured following test ASTM D1003-13 (2013, Standard Test Method for Haze and Luminous Transmittance of Transparent Plastics, ASTM International, West Conshohocken, PA), for example, which is incorporated herein by reference.

A film or coating herein can optionally further comprise a plasticizer such as glycerol, propylene glycol, ethylene glycol, and/or polyethylene glycol. In some aspects, other film components (in addition to a composition herein) can be as disclosed in U.S. Patent. Appl. Publ. Nos. 2011/0151224, 2015/0191550, 20190153674, or 2021/0095155, U.S. Patent Nos. 9688035 or 3345200, or Int. Patent Appl. Publ. No. WO20181200437, all of which are incorporated herein by reference.

A film or coating, or any suitable solid composition herein (e.g., composite), in some aspects can further comprise at least one crosslinking agent. Particles of the present disclosure can be crosslinked (covalently) to each other and/or to at least one other component (e.g., polymer, active agent) of the composition, or to a component of a substrate if the composition is applied to the substrate. Yet, in some aspects, particles herein are not crosslinked in any manner, but one or more other components of the composition are crosslinked. Crosslinking can (i) enhance the tensile strength of, and/or (ii) plasticize, a film or coating composition, for example. Crosslinking can link a film or coating to a substrate in some aspects. In some cases, a crosslinking agent such as a di- or poly-carboxylic acid, aldehyde, or polyphenol can be used to impart both plasticity and linking-to-substrate features. Suitable crosslinking agents for preparing a composition herein with crosslinking as above are contemplated to include phosphoryl chloride (POCl₃), polyphosphate, sodium trimetaphosphate (STMP), boron-containing compounds (e.g., boric acid, diborates, tetraborates such as tetraborate decahydrate, pentaborates, polymeric compounds such as Polybor@, alkali borates), polyvalent metals (e.g., titanium-containing compounds such as titanium ammonium lactate, titanium triethanolamine, titanium acetylacetonate, or polyhydroxy complexes of titanium; zirconium-containing compounds such as zirconium lactate, zirconium carbonate, zirconium acetylacetonate, zirconium triethanolamine, zirconium diisopropylamine lactate, or polyhydroxy complexes of zirconium), glyoxal, glutaraldehyde, aldehyde, polyphenol, divinyl sulfone, epichlorohydrin, polyamide-epichlorohydrin (PAE), di- or poly-carboxylic acids (e.g., citric acid, malic acid, tartaric acid, succinic acid, glutaric acid, adipic acid), dichloro acetic acid, polyamines, and diglycidyl ether (e.g., diglycidyl ether itself, diethylene glycol dimethyl ether [diglyme], ethylene glycol diglycidyl ether [EGDE], 1,4-butanediol diglycidyl ether [BDDGE], polyethylene glycol diglycidyl ether [PEGDE, such as PEG2000DGE], bisphenol A diglycidyl ether [BADGE]). Still other examples of suitable crosslinking agents are described in U.S. Pat. Nos. 4,462,917, 4,464,270, 4,477,360 and 4,799,550, and U.S. Patent Appl. Publ. No. 2008/0112907, which are all incorporated herein by reference. Yet, in some aspects, a crosslinking agent is not a boron-containing compound (e.g., as described above). Particles herein can be crosslinked, such as with any crosslinker as presently disclosed, in other contexts besides a film or coating (e.g., in a dispersion or other composition disclosed herein).

One or more conditioning agents can be comprised in a film of coating, for example, to enhance the haptics of the film or coating. A conditioning agent can be an anionic softener such as sulphated oil, soap, sulphated alcohol, and/or oi emulsion; a cationic softener such as a quatemary ammonium compound; a nonionic softener such as a polyoxyethylene derivative, polyethylene emulsion, wax emulsion, and/or silicon softener; natural fatty acid; oil; monoglyceride; diglyceride; polyglyceride; citric acid ester; lactic acid ester; and/or sugar ester such as a sucrose ester and/or sorbitan ester.

Also disclosed are articles comprising an adhesive, film, coating, or binder comprising particles herein in a dry form. Such articles (optionally, “coated articles”) comprise a substrate having at least one surface on which is disposed/deposited the coating, adhesive, film, or binder, in a substantially continuous or discontinuous manner. In some aspects, an article comprises paper, leather, wood, metal, polymer, fibrous material, masonry, drywall, plaster, and/or an architectural surface. An “architectural surface” herein is an external or internal surface of a building or other man-made structure. In some aspects, an article comprises a porous substrate such as in paper, cardboard, paperboard, corrugated board, a cellulosic substrate, a textile, or leather. Yet, in some aspects, an article can comprise a polymer such as polyamide, polyolefin, polylactic acid, polyethylene terephthalate (PET), poly(trimethylene terephthalate) (PTT), aramid, polyethylene sulfide (PES), polyphenylene sulfide (PPS), polyimide (PI), polyethylene imine (PEI), polyethylene naphthalate (PEN), polysulfone (PS), polyether ether ketone (PEEK), polyethylene, polypropylene, poly(cyclic olefins), poly(cyclohexylene dimethylene terephthalate), poly(trimethylene furandicarboxylate) (PTF), or cellophane. In some aspects, an article comprising a fibrous substrate is a fiber, yarn, fabric, fabric blend, textile, non-woven, paper, or carpet. A fibrous substrate can contain natural and/or synthetic fibers, such as cotton, cellulose, wool, silk, rayon, nylon, aramid, acetate, polyurethane urea, acrylic, jute, sisal, sea grass, coir, polyamide, polyester, polyolefin, polyacrylonitrile, polypropylene, polyaramid, or blends thereof.

A film, coating, or other composition (e.g. composite) herein can have grease/oil and/or oxygen barrier properties in some aspects. Such a composition can comprise, along with oxidized crystalline insoluble alpha-glucan, one or more components as disclosed in U.S. Patent. Appl. Publ. Nos. 20190153674 or 2021/0095155, or Int. Patent Appl. Publ. No. WO2018/200437, which are each incorporated herein by reference. For example, a film, coating, or other composition herein can comprise, optionally as a binder, one or more of polyvinyl alcohol, polyvinyl acetate, partially saponified polyvinyl acetate, silanol-modified polyvinyl alcohol, butenediol vinyl alcohol co-polymer (BVOH), polyurethane, starch, corn dextrin, carboxymethyl cellulose, cellulose ethers, hydroxyethyl cellulose, hydroxypropyl cellulose, ethyl hydroxyethyl cellulose, methyl cellulose, alginates, sodium alginate, xanthan, carrageenan, casein, soy protein, guar gums, synthetic polymers, styrene butadiene latex, and/or styrene acrylate latex. A composition for preparing a film, coating, or other composition in some aspects can comprise about 50, 55, 60, 65, 70, 75, 80, 85, 90, 95, 65-85, 65-80, 70-85, or 70-80 wt % of a binder or compound such as polyvinyl alcohol (or any other of the above-referenced compounds), and about 50, 45, 40, 35, 30, 25, 20, 15, 10, 5, 2.5, 15-35, 20-35, 15-30, or 20-30 wt % particles as presently disclosed. In some aspects, a composition for preparing a film, coating, or other composition can comprise a ratio of binder or compound (e.g., any of the above-referenced compounds such as polyvinyl alcohol or starch) to particles herein of about 7:3, 7.5:2.5, 8:2, 8.5:1.5, or 9:1, based on the wt % of each of these components in the composition. In some aspects, a film, coating, or other composition does not comprise starch, while in other aspects such as an oxygen barrier, starch can be included (e.g., as disclosed in U.S. Patent Appl. Publ. No. 2011/0135912 or U.S. Pat. Nos. 5,621,026 or 6,692,801, which are incorporated herein by reference). Grease/oil barrier properties of a coating or film composition herein can be evaluated using a standard “KIT” type test following Technical Association of the Pulp and Paper Industry (TAPPI) Test Method T-559 cm-02 (Grease resistance test for paper and paperboard, TAPPI Press, Atlanta, GA, USA; incorporated herein by reference), for example. Good grease/oil barrier/resistance function is indicated in this test by values closer to 12 on a scale of 1 to 12. Grease/oil barrier properties, as well as water/aqueous liquid barrier properties, can be evaluated by a Cobb test, if desired. A barrier herein can have a Cobb index value of less than 20, 17.5, 15, 12.5, 10, 7.5, or 5, for example. Oxygen barrier properties of a coating or film composition herein can be evaluated by measuring the oxygen transmission rate (OTR) of the coating; OTR can be determined, for example, according to ASTM F-1927-07 (2007, Standard Test Method for Determination of Oxygen Gas Transmission Rate, Permeability and Permeance at Controlled Relative Humidity Through Barrier Materiais Using a Coulometric Detector, ASTM International, West Conshohocken, PA), which is incorporated herein by reference. OTR can be determined under relative humidity conditions of about 50%-80%, 30%-55%, 35%-50%, or 30%-80%, and/or a temperature of about, or at least about, 15, 20, 25, 30, 35, 40, 45, 15-40, 15-35, 15-30, 15-25, 20-40, 20-35, 20-30, or 20-25° C., for example. Examples of substrates herein that can take advantage of a grease/oil and/or oxygen barrier coating include any of the foregoing substrates/surfaces, including a substrate comprising cellulose (e.g., paper, paperboard, cardboard, corrugated board, textile), polyethylene, polypropylene, poly lactic acid, poly(ethylene terephthalate) (e.g., MYLAR), poly(trimethylene terephthalate), polyamide, polybutylene succinate, polybutylene adipate terephthalate, polybutylene succinate adipate, poly(trimethylene furandicarboxylate), a synthetic and/or petrol-based substrate, or a bio-based substrate. Any of the foregoing film, coating, or other compositions can be in the form of a laminate or extruded product, for example, and that is optionally situated on any of the foregoing substrates.

A film, coating, or other composition (e.g., dispersion, foam, masterbatch, composite) comprising particles herein can further comprise polyurethane (e.g., any as disclosed herein) in some aspects. Such a composition can comprise about 1, 5, 10, 15, 20, 35, 30, 35, 40, 45, 50, 55, 60, 5-60, 5-50, 5-45, 5-40, 5-35, 5-30, 10-60, 10-50, 10-45, 10-40, 10-35, or 10-30 wt % of oxidized crystalline insoluble alpha-glucan herein, for example; the balance can be comprised all or mostly of (e.g., be over 90% or 95% of) one or more polyurethanes. Such a composition can be wet (e.g., a dispersion of particles and polyurethane) or dry (e.g., a masterbatch, film/coating, laminate, foam, or extruded composite of particles and polyurethane). A polyurethane herein can be of a molecular weight that is about, or at least about, 1000, 1500, 2000, 2500, 3000, 3500, 4000, 1000-3000, 1500-3000, 1000-2500, or 1500-2500, for example. Such a composition can, in some instances, be hydrolytically aged (e.g., exposed to 45-55 or −50° C., and/or 90-98% or ˜95% relative humidity, for a period of 2-4 or 3 days). In some aspects, a polyurethane composition with particles herein can be heat- and/or pressure-processable; application of heat and/or pressure for pressing, molding, extruding, or any other related processing step can be at about, or at least about, 90, 95, 100, 105, 110, 115, 120, 130, 140, 95-115, or 100-110° C., and/or at a pressure of at least about 5000, 10000, 15000, 20000, or 25000 psi, for example. Such application of heat and/or pressure can be for a time of at least about 1, 2, 3, 4, 5, 6, 7, 8, 9, 10, 15, or 30 minutes, for example. A pressed polyurethane composition in some aspects such as a film can be about, or at least about, 70%, 75%, 80%, 85%, 90%, 95%, 98%, 99%, or 100% transparent or translucent. In some aspects, any polyurethane composition presently disclosed can be made by a process that comprises providing an aqueous polyurethane dispersion, and mixing particles herein with the polyurethane dispersion (e.g., by adding an aqueous dispersion of the glucan particles). The resulting aqueous dispersion can be used directly to make a composition (e.g., a film or coating), or it can be dried to a masterbatch that is then used to prepare a composition (e.g., by melt-processing).

A film or coating in some aspects can be in the form of an edible film or coating. Such a material can, in some aspects, comprise particles herein and one or more components as described in U.S. Pat. Nos. 4,710,228, 4,543,370, 4,820,533, 4,981,707, 5,470,581, 5,997,918, 8,206,765, or 8999413, or U.S. Patent Appl. PubI. No. 2005/0214414, which are incorporated herein by reference. In some aspects, particles herein replace starch and/or starch derivatives in an edible film or coating, optionally as disclosed in any of the foregoing references. An edible film or coating can be on potato products (e.g., potato strips such as French fries), other vegetables or vegetable products (e.g., zucchini, squash, sweet potatoes, onions, okra, peppers, string beans, tomatoes, cucumbers, lettuce, cabbage, carrots, broccoli, cauliflower, brussels sprouts, bean sprouts, onions, any fresh cut version of a vegetable), mushrooms, fruits (e.g., berries such as raspberries, strawberries, or blue berries, avocados, kiwis, kumquats, oranges, tangerines, apples, pears, bananas, grapefruit, cherries, papaya, lemons, limes, mangos, peaches, cantaloupe, any fresh cut version of a fruit), and/or nuts (peanuts, walnuts, almonds, pecans, cashews, filberts/hazel nuts, Brazil nuts, macadamias), for example. Any other food disclosed herein, as appropriate, can have an edible coating, for example. These and other food products having an edible film or coating herein can be fried or baked in some aspects, and/or the film or coating provides tenderness, moisture retention, protection from moisture, crispness, dietary fiber (in place of digestible starch), oxygen barrier, freshness, and/or anti-ripening. Anti-ripening in some aspects can be measured by the degree to which a coating lowers (e.g., by at least 25%, 50%, 75%, 80%, 85%, or 90%) the emission of a gaseous ripening hormone, such as ethylene, by a plant-based product (e.g., at 15-30, 15-25, or 20-25° C.), and/or by the degree to which plant product softening and/or sweetening is decreased by a coating. An edible coating in some aspects can be prepared by applying an aqueous dispersion comprising particles herein (e.g., at 5-15, 5-12, 5-10, 7.5-15, 7.5-12, or 7.5-10 wt % in water or aqueous solution) to a food product and drying the dispersion (e.g., by air drying, forced air drying, vacuum drying, and/or heating).

A coating composition in some aspects, which can be used to prepare a coating herein, can comprise any of the foregoing components/ingredients/formulations. In some aspects, a coating composition is a latex composition, such as described below,

A composition herein comprising oxidized crystalline insoluble alpha-glucan can be a latex composition in some aspects (a rubber component may, or may not be, present in such a composition). Examples of latex compositions herein include paint (e.g., primer, finishing/decorative), adhesives, films, coatings, and binders. Formulations and/or components (in addition to a composition herein) of a latex composition herein can be as described in, for example, U.S. Pat. Nos. 6,881,782, 3,440,199, 3,294,709, 5,312,863, 4,069,186, or 6297296, or U.S. Patent Appl. Publ. No. 2020/0263026, which are all incorporated herein by reference.

A composition as presently disclosed can be present in a latex composition in any useful amount, such as at about, or at least about, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 15%, 20%, 25%, 30%, 40%, 45%, 50%, 55%, 60%, 65%, 70%, 75%, 0.01%-75% 0.01%-5%, 5%-20%, 20%-50%, or 50%-75% based on the weight of all the dispersed solids of the latex.

A latex composition in some aspects can comprise a polymer polymerized from at least one ethylenically unsaturated monomer (e.g., monoethylenically unsaturated monomer); polyurethane; epoxy, and/or a rubber elastomer. Examples of monoethylenically unsaturated monomers herein include vinyl monomers, acrylic monomers, allylic monomers, acrylamide monomers, monocarboxylic unsaturated acids and dicarboxylic unsaturated acids.

Examples of suitable vinyl monomers of a polymer in a latex composition herein include any compound having vinyl functionality (i.e., ethylenic unsaturation) such as vinyl esters (e.g., vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates), vinyl aromatic hydrocarbons (e.g., styrene, methyl styrenes and similar lower alkyl styrenes, chlorostyrene, vinyl toluene, vinyl naphthalene, divinyl benzene), vinyl aliphatic hydrocarbons (e.g., vinyl chloride; vinylidene chloride; alpha olefins such as ethylene, propylene and isobutylene; conjugated dienes such as 1,3-butadiene, methyl-2-butadiene, 1,3-piperylene, 2,3-dimethyl butadiene, isoprene, cyclohexene, cyclopentadiene, and dicyclopentadiene) and vinyl alkyl ethers (e.g., methyl vinyl ether, isopropyl vinyl ether, n-butyl vinyl ether, isobutyl vinyl ether), but excluding compounds having acrylic functionality (e.g., acrylic acid, methacrylic acid, esters of such acids, acrylonitrile, acrylamides). In some aspects, a latex composition herein comprises a vinyl acetate-ethylene copolymer, carboxylated vinyl acetate-ethylene copolymer, and/or or polyvinyl acetate.

Examples of suitable acrylic monomers of a polymer in a latex composition herein include alkyl acrylates, alkyl methacrylates, acrylate acids, methacrylate acids, aromatic derivatives of acrylic and methacrylic acid, acrylamides, and acrylonitrile. Typically, alkyl acrylate and methacrylic monomers (also referred to as alkyl esters of acrylic or methacrylic acid) have an alkyl ester portion containing from 1 to about 18 carbon atoms per molecule, or from 1 to about 8 carbon atoms per molecule. Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, and 1-adamantyl methacrylate. If acid functionality is desired, acids such as acrylic acid or methacrylic acid can also be used.

A latex composition in some aspects comprises a polyurethane polymer. Examples of suitable polyurethane polymers are those comprising polysaccharides as disclosed in U.S. Patent Appl. Publ. No. 2019/0225737, which is incorporated herein by reference. A latex comprising a polyurethane can be prepared, for example, as disclosed in U.S. Patent Appl. Publ. No. 2016/0347978, which is incorporated herein by reference, and/or comprise the reaction product of one or more polyisocyanates with one or more polyols. Useful polyols include polycarbonate polyols, polyester polyols and polyether polyols, for example. Polycarbonate polyurethane herein can be formed as the reaction product of a polyol such as 1,3-propanediol, 1,4-butanediol, 1,6-hexanediol, diethylene glycol, or tetraethylene glycol, with a diaryl carbonate such as diphenyl carbonate or phosgene. At least one polyisocyanate herein can be an aliphatic polyisocyanate, aromatic polyisocyanate, or polyisocyanate that has both aromatic and aliphatic groups. Examples of polyisocyanates include 1,6-hexamethylene diisocyanate, isophorone diisocyanate, 2,4-toluene diisocyanate, 2,6-toluene diisocyanate, mixtures of 2,4-and 2,6-toluene diisocyanate, bis(4-isocyanatocyclohexyl) methane, 1,3-bis(1-isocyanato-1-methylethyl)benzene, bis(4-isocyanatophenyl)methane, 2,4′-diphenylmethane diisocyanate, 2,2′-diphenylmethane diisocyanate, 2,4-diisocyanatotoluene, bis(3-isocyanatophenyl)methane, 1,4-diisocyanatobenzene, 1,3-diisocyanato-o-xylene, 1,3-diisocyanato-p-xylene, 1,3-dilsocyanato-m-xylene, 2,4-dilsocyanato-1-chlorobenzene, 2,4-diisocyanato-1-nitrobenzene, 2,5-diisocyanato-1-nitrobenzene, m-phenylene diisocyanate, hexahydrotoluene diisocyanate, 1,5-naphthalene diisocyanate, 1-methoxy-2,4-phenylene diisocyanate, 4,4′-biphenylmethane diisocyanate, 4,4′-biphenylene diisocyanate, 3,3′-dimethyl-4,4′-diphenylmethane, diisocyanate, 3,3′-4,4′-diphenylmethane diisocyanate, and 3,3′-dimethyldiphenylmethane-4,4′-diisocyanate. Also useful herein are polyisocyanate homopolymers comprising allophanate, biuret, isocyanurate, iminooxadiazinedione, or carbodiimide groups, for example. A polyol herein can be any polyol comprising two or more hydroxyl groups, for example, a C2 to C12 alkane diol, ethylene glycol, 1,2-propylene glycol, 1,3-propylene glycol, isomers of butane diol, pentane diol, hexane diol, heptane diol, octane diol, nonane diol, decane diol, undecane diol, dodecane diol, 2-methyl-1,3-propane diol, 2,2-dimethyl-1,3-propane diol (neopentyl glycol), 1,4-bis(hydroxymethyl)cyclohexane, 1,2,3-propane triol (glycerol), 2-hydroxymethyl-2-methyl-1,3-propanol (trimethylolethane), 2-ethyl-2-hydroxymethyl-1,3-propanediol (trimethylolpropane), 2,2-bis(hydroxymethyl)-1,3-propane diol (pentaerythritol); 1,4,6-octanetriol; chloropentanediol; glycerol monoalkyl ether; glycerol monoethyl ether; diethylene glycol; 1,3,6-hexanetriol; 2-methylpropanediol; 2,2,4-trimethyl-1,3-pentanediol, cyclohexanedimethanol, polymeric polyols, for example, polyether polyols or polyester polyols. In some aspects, a polyol herein can be poly(oxytetramethylene) glycol, polyethylene glycol, or poly 1,3-propane diol. A polyol in some aspects can be polyester polyol, such as one produced by transesterification of aliphatic diacids with aliphatic diols. Suitable aliphatic diacids include, for example, C3 to C10 diacids, malonic acid, succinic acid, glutaric acid, adipic acid, pimelic acid, suberic acid, azelic acid, sebacic acid. In some aspects, aromatic and/or unsaturated diacids can be used to form a polyester polyol.

A latex composition in some aspects comprises an epoxy polymer/resin (polyepoxide), such as bisphenol A epoxy resin, bisphenol F epoxy resin, Novolac epoxy resin, aliphatic epoxy resin, or glycidylamine epoxy resin.

A latex composition in some aspects comprises a rubber elastomer. In some aspects, a rubber elastomer can include one or more diene-based sulfur-vulcanizable elastomers having a glass transition temperature (Tg) below −30° C., as determined, for example, by dynamic mechanical analysis. In further examples, a rubber elastomer herein includes natural rubber, synthetic polyisoprene, polybutadiene rubber, styrene/butadiene copolymer rubber, ethylene propylene diene monomer rubber, hydrogenated nitrile butadiene rubber, neoprene, styrene/isoprene/butadiene terpolymer rubber, butadiene/acrylonitrile rubber, polyisoprene rubber, isoprene/butadiene copolymer rubber, nitrile rubber, ethylene-acrylic rubber, butyl and halobutyl rubber, chlorosulfonated polyethylene, fluoroelastomer, hydrocarbon rubber, polybutadiene, or silicone rubber.

The liquid component of a latex composition herein can be water or an aqueous solution. An aqueous solution of a latex in some aspects can comprise an organic solvent that is either miscible or immiscible with water. Suitable organic solvents herein include acetone, methyl ethyl ketone, butyl acetate, tetrahydrofuran, methanol, ethanol, isopropanol, diethyl ether, glycerol ethers, hexane, toluene, dimethyl acetamide, dimethylformamide, and dimethyl sulfoxide.

A latex composition herein can further comprise one or more additives in some aspects. Examples of additives herein include dispersants, rheological aids, antifoams, foaming agents, adhesion promoters, flame retardants, bactericides, fungicides, preservatives, optical brighteners, fillers, anti-settling agents, coalescing agents, humectants, buffers, pigments/colorants (e.g., metallic oxides, synthetic organic pigments, carbon black), viscosity modifiers, antifreeze, surfactants, binders, crosslinking agents, anticorrosion agents, hardeners, pH regulators, salts, thickeners, plasticizers, stabilizers, extenders, and matting agents. Examples of pigments herein include titanium dioxide (TiO₂), calcium carbonate, diatomaceous earth, mica, hydrated aluminum oxide, barium sulfate, calcium silicate, clay, silica, talc, zinc oxide, aluminum silicate, nepheline syenite, and mixtures thereof. In some aspects, a latex composition is essentially free from (e.g., less than 1, 0.5, 0.1, or 0.01 wt % of component) starch, starch derivative (e.g., hydroxyalkyl starch), cellulose, and/or cellulose derivative (e.g., carboxymethyl cellulose).

A latex composition in the form of a paint or other coloring agent herein can have a pigment volume concentration (PVC) of about 3% to about 80% in some aspects. As examples, a flat paint can have a PVC in the range of about 55-80%, a primer or undercoat can have a PVC in the range of about 30-50%, and/or a gloss colored paint can have a PVC in the range of about 3-20%. A paint or other coloring agent in some aspects can have a PVC of about 55%, 60%, 65%, 70%, 75%, 80%, 55-80%, 55-75%, 55-70%, 60-80%, 60-75%, 60-70%, 63-67%, 64-66%, 65-80%, 65-75%, or 65-70%. A PVC value herein can be that of a particular pigment (or mix of pigments) such as those disclosed above (e.g., titanium dioxide), for instance. A composition of the present disclosure is believed to provide one or more physical properties to a latex composition (e.g., for use as a paint or other coloring agent): opacity, less pigment needed, increased hardness, reduced tackiness, decreased gloss (i.e., providing a matte effect), increased shear strength, better abrasion resistance, improved dry time, improved fade resistance, lower blistering, and/or improved hand (a less tacky feel), for example, as compared to a latex composition that only differs by not comprising the disclosed composition.

A latex composition herein can be applied to the substrate of an article (above) using any method known in the art. Typically, after application of the latex composition, at least a portion of the aqueous solution is removed, for example by drying, to provide an adhesive, film, coating, or binder comprising the latex composition in a dry or semi-dry form. Suitable application methods include air knife coating, rod coating, bar coating, wire bar coating, spray coating, brush coating, cast coating, flexible blade coating, gravure coating, jet applicator coating, short dwell coating, slide hopper coating, curtain coating, flexographic coating, size-press coating, reverse roll coating, and transfer roll coating. A latex composition can be applied on at least a portion of a substrate, and can be in one or more coats/applications, for example.

Some aspects herein are drawn to a pigment-comprising composition. A pigment-comprising composition can be in a liquid form (e.g., an aqueous or non-aqueous composition herein) or solid form (e.g., a dry composition herein). Examples of a pigment-comprising composition herein include any of such compositions disclosed elsewhere herein (e.g., paint, primer, stain), ink, dye (e.g., food-coloring dye, fabric-coloring dye), resin, sunscreen, and cosmetics (e.g., mascara, blush, nail varnish/polish, lipstick, gloss, eyeliner, foundation, eye shadow, skin decoration composition). A pigment in a pigment-comprising composition can be any pigment herein, for example. Examples of a pigment for these and/or other aspects herein include oxides of titanium (e.g., titanium dioxide), zinc, iron, zirconium, cerium, and chromium; manganese violet; ultramarine blue; chromium hydrate; Prussian Blue; zinc sulfide; nitroso, nitro, azo, xanthene, quinoline, anthraquinone and/or phthalocyanine compounds; metal complex compounds; and isoindolinone, isoindoline, quinacridone, perinone, perylene, diketopyrrolopyrrole, thioindigo, dioxazine, triphenylmethane and/or quinophthalone compounds. Further pigment examples useful herein are disclosed in U.S. Patent. Appl. Publ. No. 2006/0085924, which is incorporated herein by reference.

A composition herein comprising oxidized crystalline insoluble alpha-glucan can be in the form of a composite (e.g., rubber composite or polyurethane composite) such as disclosed herein or in U.S. Patent Appl. Pubt. Nos. 2019/0225737, 2017/0362345, or 202010181370, all of which are incorporated herein by reference (a rubber component may, or may not be, present in such a composition). It can optionally be stated that a composite as presently disclosed comprises at least one polymer in addition to a composition of the disclosure. One or more of the above components (e.g., a rubber or polyurethane) of a latex composition can optionally be an additional polymer in such a composite. An additional polymer of a composite herein can be rubber, polyurethane, thermoplastic polymer, polyethylene, polypropylene, ethylene copolymer, polyvinyl butyrate, polylactic acid, polyvinyl alcohol, polyamide, polyether thermoplastic elastomer, polyester, polyether ester, ethylene vinyl alcohol copolymer, starch, cellulose, or any suitable polymer as disclosed above for latex components.

Rubber in some aspects can be one or more of natural rubber, synthetic rubber, polyisoprene, polybutadiene, styrene-butadiene copolymer, styrene-isoprene copolymer, butadiene-isoprene copolymer, styrene-butadiene-isoprene terpolymer, ethylene propylene diene monomer rubber, hydrogenated nitrile butadiene rubber, silicone rubber, or neoprene, for instance. Examples of composites herein comprising rubber include tires (e.g., auto/bicycle; pneumatic tire; including tire treads and/or sidewalls), belts (e.g., conveyor belts, power transmission belts), hoses, gaskets, footwear (e.g., shoes, sneakers, boots; soles, cushioning, and/or aesthetic features), coatings, films, and adhesives. Rubber composites herein typically are vulcanized. It is contemplated that, in some aspects, inclusion of a composition herein in a composite comprising rubber can provide advantages such as lower cost, lower density, lower energy consumption during processing, and/or better or equal performance as compared to use of an incumbent filler such as carbon black or silica (e.g., increased wet traction, reduced rolling resistance, lighter weight, and/or mechanical strength); such performance enhancements can be with tires in some aspects. In some aspects, a composition herein replaces about, or at least about, 25, 30, 35, 40, 45, 50, 55, 60, 65, 70, 75, 80, 85, 90, 95, or 100 wt % of an incumbent filler (e.g., carbon black, or silica) that is typically used in a rubber composite such as a tire. It is noted that rubber composite tires currently on the market (that do not comprise a composition herein) typically comprise up to about 30 wt % of an incumbent filler such as carbon black. Thus, a rubber composite herein such as a tire can comprise about, or at least about, 5, 10, 15, 20, 25, or 30 wt % a composition as presently disclosed, for example, A rubber composition herein can have a low minimum elastic torque (M_{L}) (e.g., less than, or about, 0.10, 0.08, 0.06, 0.04, 0.03, or 0.02 dNm [deciNewton-meter]) in some aspects, and so a method of mixing a rubber composition during its preparation is disclosed.

Non-limiting examples of compositions and methods disclosed herein include:
1. A composition comprising oxidized insoluble alpha-glucan and a rubber component, wherein the oxidized insoluble alpha-glucan is produced by contacting an insoluble alpha-glucan under aqueous conditions with at least one agent that is capable of oxidizing the insoluble alpha-glucan, wherein (i) at least about 50% of the glycosidic linkages of the insoluble alpha-glucan are alpha-1,3 glycosidic linkages, (ii) the insoluble alpha-glucan has a weight-average degree of polymerization (DPw) of about 10 (or 15) to 100, and (iii) the insoluble alpha-glucan is in the form of particles having a degree of crystallinity of at least about 0.65.
2. The composition of embodiment 1, wherein at least about 90% of the glycosidic linkages of the insoluble alpha-glucan are alpha-1,3 glycosidic linkages.
3. The composition of embodiment 1, wherein at least about 99% of the glycosidic linkages of the insoluble alpha-glucan are alpha-1,3 linkages.
4. The composition of embodiment 1, 2, or 3, wherein the DPw of the insoluble alpha-glucan is about 35 to about 100.
5. The composition of embodiment 1, 2, or 3, wherein the DPw of the insoluble alpha-glucan is about 35 to about 60.
6. The composition of embodiment 1, 2, 3, 4, or 5, wherein the agent comprises an N-oxoammonium salt.
7. The composition of embodiment 1, 2, 3, 4, 5, or 6, wherein the rubber component comprises a diene-based sulfur-vulcanizable rubber or peroxide-vulcanizable rubber having a glass transition temperature (Tg) below −30° C. as determined by dynamic mechanical analysis.
8. The composition of embodiment 1, 2, 3, 4, 5, 6, or 7, wherein the rubber component comprises natural rubber.
9. The composition of embodiment 1, 2, 3, 4, 5, 6, 7, or 8, wherein the rubber component comprises synthetic polyisoprene, styrene butadiene copolymer rubber, ethylene propylene diene monomer rubber, hydrogenated nitrile butadiene rubber, polybutadiene, or neoprene (with respect to embodiment 8, the rubber component is in addition to the natural rubber).
10. The composition of embodiment 1, 2, 3, 4, 5, 6, 7, 8, or 9, wherein the rubber component comprises silicone rubber (with respect to embodiments 7, 8, or 9, the silicone rubber is in addition to the recited rubber component).
11. The rubber composition of embodiment 1, 2, 3, 4, 5, 6, 7, 8, 9, or 10, wherein the rubber composition comprises about 5 to about 100 parts-per-hundred of the oxidized insoluble alpha-glucan, wherein the parts-per-hundred is based on the weight of the rubber component in the composition.
12. The rubber composition of embodiment 1, 2, 3, 4, 5, 6, 7, 8, 9, 10, or 11, wherein the rubber composition further comprises carbon black and/or silica.
13. The rubber composition of embodiment 1, 2, 3, 4, 5, 6, 7, 8, 9, 10, 11, or 12, wherein the rubber composition further comprises at least one of a filler, anti-oxidant, anti-ozonant, processing aid, compatibilizer, bonding agent, tackifier, curing agent, accelerator, or coupling agent.
14. The rubber composition of embodiment 1, 2, 3, 4, 5, 6, 7, 8, 9, 10, 11, 12, or 13, wherein the rubber composition further comprises a polyetheramine.
15. The rubber composition of embodiment 1, 2, 3, 4, 5, 6, 7, 8, 9, 10, 11, 12, 13, or 14, wherein the rubber composition comprises a coupling agent that comprises (i) an organic silane compound having a sulfide group, amino group, mercapto group, vinyl group, methacryl group, epoxy group, halogen, or alkoxy group, or (ii) bis(3-triethoxysilylpropyl)tetrasulfide, bis(3-triethoxysilyipropyl)disulfide, bis(2-triethoxysilylethyl)tetrasulfide, 3-mercaptopropyl trimethoxysilane, 3-mercaptopropyl triethoxysilane, 3-nitropropyl trimethoxysilane, or 3-aminopropyl triethoxysilane.
16. The rubber composition of embodiment 1, 2, 3, 4, 5, 6, 7, 8, 9, 10, 11, 12, 13, 14, or
15, wherein the rubber composition is a belt, seal, footwear, valve, tubing, mat, gasket, coating, film, or adhesive.
17. The rubber composition of embodiment 1, 2, 3, 4, 5, 6, 7, 8, 9, 10, 11, 12, 13, 14, or
15, wherein the rubber composition is tire.
18. An article comprising a rubber composition of embodiment 1, 2, 3, 4, 5, 6, 7, 8, 9, 10, 11, 12, 13, 14, or 15, optionally wherein the article is a tire, belt, seal, footwear, valve, tubing, mat, gasket, coating, film, or adhesive.
19. A method of producing a rubber composition of embodiment 1, 2, 3, 4, 5, 6, 7, 8, 9, 10, 11, 12, 13, 14, 15, 16, or 17, the method comprising: (a) providing an aqueous dispersion comprising a mixture the oxidized insoluble alpha-glucan and the rubber component, (b) coagulating the dispersion/mixture to produce a coagulated mass, and (c) optionally drying the coagulated mass.
20. The method of embodiment 19, further comprising: (d) compounding the coagulated mass of step (b) or (c) with at least one rubber additive, optionally wherein the rubber additive is selected from a filler, anti-oxidant, anti-ozonant, processing aid, compatibilizer, bonding agent, tackifier, curing agent, accelerator, or coupling agent.
21. A rubber composition as recited in embodiment 1, 2, 3, 4, 5, 6, 7, 8, 9, 10, 11, 12, 13, 14, 15, 16, or 17, or an article as recited in embodiment 18, or a method as recited in embodiment 19 or 20, but wherein the rubber composition comprises another oxidized insoluble alpha-glucan that is produced by contacting an insoluble alpha-glucan under aqueous conditions with at least one agent that is capable of oxidizing the insoluble alpha-glucan, wherein (A) (i) at least about 50% of the glycosidic linkages of the insoluble alpha-glucan are alpha-1,3 glycosidic linkages, and/or (ii) the insoluble alpha-glucan has a weight-average degree of polymerization (DPw) of about 10 (or 15) to 4000, or a DPw of about, or more than about, 100, 200, 300, 400, 500, 600, 700, 800, 900, 1000, 1100, 1200, 1300, or 1400 (optionally, the insoluble alpha-glucan has a crystallinity index of less than 0.65), (B) the insoluble alpha-glucan comprises a graft copolymer herein, and/or (C) the insoluble alpha-glucan has a high molecular weight as reflected by high intrinsic viscosity, wherein the another oxidized insoluble alpha-glucan is instead of, or in addition to, the oxidized insoluble alpha-glucan as recited in embodiment 1.
22. A composition as recited in embodiment 1, 2, 3, 4, 5, or 6, but wherein the composition does not comprise (or does not necessarily comprise) a rubber component.

### EXAMPLES

The present disclosure is further exemplified in the following Examples. It should be understood that these Examples, while indicating certain aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

Materials/Methods Representative Preparation of Highly Crystalline Insoluble Alpha-Glucan Insoluble alpha-1, 3-glucan was first prepared by enzymatic synthesis in a manner similar to what is described in U.S. Patent Appl. Publ Nos. 2018/0340199 and
2019/0078063, which are both incorporated herein by reference. In general, a glucan synthesis reaction was performed comprising water, sucrose, buffer, filtrate from an earlier glucan synthesis reaction (contains, e.g., gluco-oligosaccharide byproducts of the earlier glucan synthesis reaction), and an amino acid-modified, high product-yielding glucosyltransferase enzyme. Following the reaction, the alpha-1,3-glucan product (insoluble, ˜100% alpha-1,3 linkages, DPw of about 800) was filtered and washed to remove most fructose and other residual soluble sugars (e.g., glucose, sucrose, leucrose, DP2-DP8 gluco-oligosaccharides). Samples of the washed product were then either collected into wet cakes (never-dried) of about 20-40 wt % solids or dried in a rotary dryer to powders of about 88-95 wt % solids.

Samples of both never-dried and dried insoluble alpha-1,3-glucan were then subjected to hydrochloric acid hydrolysis procedures at a pH of almost 0 at 80° C. to produce reduced molecular weight insoluble alpha-1,3-glucan. Each hydrolysis reaction as initiated contained 8 wt % alpha-1,3-glucan. Procedures disclosed in U.S. Patent Appl. Publ. No. 2013/0244287 (incorporated herein by reference), which describes mineral acid hydrolysis of insoluble alpha-1,3-glucan to soluble alpha-1,3-glucan, can be applied with appropriate modification to hydrolyze alpha-1,3-glucan to a lower molecular weight, but insoluble, form. Hydrolysis reactions were allowed to proceed for 1 hour, 8 hours, 1 day, or 3 days before being neutralized. Each hydrolyzed, insoluble alpha-1,3-glucan product was then analyzed for molecular weight. Insoluble alpha-1,3-glucan with a weight-average degree of polymerization (DPw) of roughly 40-60 was produced after one day of hydrolysis of either never-dried or dried insoluble alpha-1,3-glucan. This molecular weight was stable, remaining at a similar DPw for the duration of hydrolysis under the very low pH conditions. In a separate hydrolysis, insoluble alpha-1,3-glucan with a DPw of about 39 was produced.

Crystallinity (or crystallinity index [Cl]) of the alpha-1,3-glucan samples was measured by wide-angle X-ray scattering (WAXS) as follows. Glucan powder samples were dried for a minimum of two hours or overnight (but sometimes over the weekend) in a vacuum oven set at 60° C. Immediately before starting the diffraction scan, each sample was removed from the oven and transferred into a stainless steel holder with a well of about 1.5 cm wide by 4 cm long by 4 mm deep. The well was open at the side such that powder could be poured in through the side, with a glass plate clipped onto the top of the holder. The powder was packed down several times throughout the filling process by hitting the opposite side of the holder against the table repeatedly. Finally, the holder was turned right-side-up, the glass plate was removed, and the holder was loaded into a diffractometer. The time from the opening of the oven to the start of the scan was five minutes or less. An X'PERT MPD POWDER diffractometer (PANalytical B.V., The Netherlands) in reflection mode was used to measure the X-ray diffraction pattern of each powder sample. The X-ray source was a Cu X-ray tube line source with an optical focusing mirror and a 1/16° narrowing slit. X-rays were detected with a 1-D detector and an anti-scatter slit set at ⅛. Data were collected in the range of 4 to 60 degrees of two-theta at 0.1 degrees per step. The scan took about 46 minutes in total. The resulting X-ray pattern was then analyzed by subtracting a linear baseline from 7.2 to 30.5 degrees, subtracting the XRD pattern of a known amorphous alpha-1,3-glucan sample that had been scaled to fit the current data, and then fitting the remaining crystal peaks in that range with a series of Gaussian curves corresponding to known dehydrated alpha-1,3-glucan crystal reflections. The area corresponding to the crystal peaks was then divided by the total area under the baseline-subtracted curve to yield a crystallinity index.

The crystallinity of the alpha-1,3-glucan samples prepared above by hydrolysis was compared to the crystallinity of enzymatically polymerized alpha-1,3-glucan that was not subjected to hydrolysis. The hydrolyzed alpha-1,3-glucan had substantially greater crystallinity (over 0.65) compared to non-hydrolyzed alpha-1,3-glucan. In particular, hydrolyzed alpha-1,3-glucan with a DPw of 50 (made by acid-hydrolyzing, as above, wet cake for 48 hours at 40° C.) had a crystallinity of about 0.76. A sample of hydrolyzed alpha-1,3-glucan with a DPw of 94 (made by acid-hydrolyzing, as above, wet cake for 1 hour at 40° C.) had a crystallinity of about 0.69. However, samples of non-hydrolyzed alpha-1,3-glucan (˜100% alpha-1,3 linkages) produced enzymatically and having DPw values ranging from ˜230 to ˜830 had lower crystallinities (the molecular weight of alpha-1,3-glucan as produced enzymatically can be modulated to be within the range of DPw 230-830 using a technique as described in, for example, U.S. Patent Appl. Publ. No. 2015/0064748, which is incorporated herein by reference).

Using electron microscopy, the microstructure of hydrolyzed alpha-1,3-glucan (DPw 50, 0.76° C.1, 1.2 PD1) was compared to that of non-hydrolyzed alpha-1,3-glucan (DP ˜800) (as produced above). The glucan samples were imaged by dry-cast electron microscopy using phosphotungstate as a contrast agent, as follows. Slurries of DPw 50 and DPw ˜800 alpha-1,3-glucan were purified by multiple rounds of centrifugation and redispersion into Dl water. The final purified glucan samples were diluted 100-fold and then sonicated for 3 minutes. Once sonication was completed, supernatant from each preparation was isolated to prepare a dry-cast transmission electron microscopy (TEM) sample on a copper mesh TEM grid. Phosphotungstic acid was then used for negative contrast staining, after which TEM imaging was performed. The captured TEM images usually were from sections located at the edge of a larger thick sample deposited on the TEM grid. The hydrolyzed alpha-1,3-glucan (DPw 50) exhibited two-dimensional structures (>about 90 wt % of material that was not aggregated was in the form of plates), whereas the non-hydrolyzed alpha-1,3-glucan (DPw ˜800) exhibited larger, three-dimensional fibrillar structures. TEM imaging of non-hydrolyzed alpha-1,3-glucan (˜100% alpha-1,3 linkages) produced enzymatically and having a DPw of about 260 showed a microstructure very similar to that of non-hydrolyzed alpha-1,3-glucan (DPw ˜800).

### Example 1

Producing Elastomeric Compositions Comprising Crystalline Insoluble Alpha-Glucan that Has Been Oxidized

Elastomeric compositions were prepared in this Example comprising oxidized insoluble crystalline alpha-glucan. In particular, rubber compositions were prepared that comprised insoluble microcrystalline alpha-1,3-glucan (MCG) (DPw 40-50, ˜100% alpha-1,3 linkages, 0.76° C.1 [crystallinity index]) that had been oxidized with TEMPO (2,2,6,6-tetramethylpiperidine 1-oxyl). Oxidized MCG was shown to enhance physical reinforcement of natural rubber (NR) composites.

MCG was prepared and analyzed following methodology similar to what is described above in the Materials/Methods section. The MCG was then modified using mild TEMPO oxidation conditions according to Mishra et al. (2012, Bioresources 7:422-436), which is incorporated herein by reference. In particular, a mixture of NaBr (1.25 mmol/g MCG), TEMPO (0.083 mmol/g MCG) and NaClO (2.5 mmol/g MCG) was added to a dispersion of MCG (7 wt %) in water. The resulting slurry was stirred at room temperature for 3 hours while maintaining a pH of 10 using NaOH (1 M). At the conclusion of the oxidation reaction, the dispersion was neutralized with 0.5 M HCl to a pH between 7 and 8.

To incorporate oxidized MCG into rubber composites, the dispersion of oxidized MCG was mixed with a natural rubber (NR) latex (60 wt %) into a slurry at 4000 rpm for 4 minutes. The mixture was then coagulated with formic acid (5 vol %). The coagulum was divided into smaller parts, dried (<3 wt % moisture) and milled. The dried coagulum (masterbatch) was then used for rubber compounding. A masterbatch was similarly made containing natural rubber and non-oxidized MCG.

The above-prepared MCG NR masterbatches were individually mixed with rubber additives according to the formulation in Table 1 (below) using an internal mixer (two passes) and the following process. In the first pass, the internal mixer was heated to 120° C. and the masterbatch with all the additives except sulfur and CBS were added. The temperature was increased to 150° C. during mixing and held for two minutes at 150° C. As comparative examples, incumbent fillers silica or carbon black were added with NR in the first pass. In the second pass—for all the rubber preparations—the mixer was heated to 80° C. and the mixed rubber from the first pass was added along with sulfur and CBS. Each rubber sample was mixed until the temperature reached 95° C. Once the rubber samples cooled, they were each milled in a two-roll mill and compression-molded and cured into test specimens for characterization.

TABLE 1
Formulation of Rubber Composites

| Component | Additive | phr ^{a} |
|---|---|---|
| Polymer | NR latex | 100 |
| Filler ^{b} | MCG | 15 |
| | TEMPO-oxidized MCG | 15 |
| | Ultrasil ® 7000 (silica) | 19.3 |
| | N234 (carbon black) | 14.6 |
| Aromatic processing oil | VIVATEC 500 | 5 |
| (TDAE) | | |
| Curative | Zinc oxide | 4 |
| Curative | Stearic acid | 2 |
| Anti-degradant | 6PPD | 2 |
| Anti-oxidant | TMQ | 2 |
| Processing aid | Struktol ® KK49 | 2 |
| Accelerator | CBS | 1.75 |
| Curative | Sulfur | 1.75 |

^{a} Abbreviations or meanings: phr, parts-per-hundred rubber. NR, natural rubber. TDAE, treated distillate aromatic extract. CBS, N-cyclohexyl-2-benzothiazolesulfenamide. 6PPD, N-(1,3-dimethylbutyl)-N’-phenyl-1,4-benzenediamine.TMQ, 2,2,4-trimethyl-1,2-dihydroquinoline.
^{b} Each filler was loaded at 7.2 vol %.

The MCG and TEMPO-oxidized MCG natural rubber composites, and the comparative natural rubber composites that contained conventional fillers (carbon black or silica), w ere tested for physical and dynamic properties. The composites that were compared had the same volumetric loading of fillers (7.2 vol %). A natural rubber composite that did not contain a filler was similarly tested. The results of these analyses are summarized in Table 2 (below).

TABLE 2
Summary of Key Physical and Dynamic Properties of Rubber Composites

| | Filler | | | | |
|---|---|---|---|---|---|
| | | | | | TEMPO- |
| | | Carbon | | | oxidized |
| Key Properties | Unfilled | Black | Silica | MCG | MCG |
| M_{H} (dNm) | 6.65 | 10.19 | 10.05 | 7.013 | 8.470 |
| M_{L} (dNm) | 1.005 | 2.110 | 2.07 | 0.819 | 1.42 |
| Ts2 (min) | 3.6 | 4.91 | 7.80 | 4.1 | 3.4 |
| T₀₅ (min) @ 150° C. | 2:52 | 2:48 | 0:11 | 03:56 | 02:50 |
| T₉₀ (min) @ 150° C. | 6:10 | 6:27 | 10:18 | 06:34 | 04:56 |
| Density (g/cm³) | 0.9115 | 1.023 | 1.027 | 0.9812 | 0.987 |
| Hardness (Shore A) | 39 | 51.4 | 50.9 | 41 | 44.5 |
| ΔG′ (Payne effect. 0.28- | 130.911 | | | 310.857 | 156.435 |
| 446%) (kPa) | | | | | |
| Swelling degree (%) | 322 | 170 | 183 | 280 | 227 |
| Tensile stress (MPa) | 20.5093 | 29.3 | 26.23 | 26.48 | 30.4 |
| Ultimate elongation (%) | 591.468 | 579.62 | 590.8 | 659.09 | 646.3 |
| M300 (MPa) | 2.4 | 5.99 | 4 | 3.31 | 4.0 |
| M100 (MPa) | 0.84 | 1.52 | 1.49 | 0.99 | 1.2 |
| Tan delta @ 25° C. | 0.0175 | 0.0308 | 0.0185 | 0.0215 | 0.0158 |
| Tan delta @ 0° C. | 0.027 | 0.031 | 0.023 | 0.047 | 0.021 |
| Tan delta @ −10° C. | 0.031 | 0.0425 | 0.032 | 0.083 | 0.028 |
| Tan delta @ −60° C. | 1.15 | 0.705 | 0.68 | 0.128 | 0.905 |
| Tg (° C.) | −53.7 | −53.1 | −52.5 | −55.01 | −62.14 |

The following conclusions can be drawn from Table 2:
MCG and oxidized MCG natural rubber composites have a lower density as compared to natural rubber composites with incumbent fillers (silica or carbon black).
Oxidized MCG natural rubber composite has higher M300 and M10 values as compared to MCG natural rubber composite.
Oxidized MCG natural rubber composite demonstrates comparable tensile strength with higher elongation as compared to natural rubber composites with incumbent fillers.
MCG and oxidized MCG natural rubber composites have lower tan delta at 25° C. (good rolling resistance) as compared to natural rubber composites with incumbent fillers.
MCG natural rubber composite has higher tan delta at 0, -10 and −60° C. (good wet traction and ice traction) as compared to natural rubber composites with incumbent fillers.
MCG and oxidized MCG natural rubber composites have comparable cure times and lower M_{L} for good processing as compared to natural rubber composite with carbon black.

What is claimed is:

1. A composition comprising oxidized insoluble alpha-glucan and a rubber component, wherein the oxidized insoluble alpha-glucan is produced by contacting an insoluble alpha-glucan under aqueous conditions with at least one agent that is capable of oxidizing the insoluble alpha-glucan, wherein
(i) at least about 50% of the glycosidic linkages of the insoluble alpha-glucan are alpha-1,3 glycosidic linkages,
(ii) the insoluble alpha-glucan has a weight-average degree of polymerization (DPw) of about 15 to 100, and
(iii) the insoluble alpha-glucan is in the form of particles having a degree of crystallinity of at least about 0.65.

2. The composition of claim 1, wherein at least about 90% of the glycosidic linkages of the insoluble alpha-glucan are alpha-1,3 glycosidic linkages.

3. The composition of claim 1, wherein at least about 99% of the glycosidic linkages of the insoluble alpha-glucan are alpha-1,3 linkages.

4. The composition of claim 1, wherein the DPw of the insoluble alpha-glucan is about 35 to about 100.

5. The composition of claim 1, wherein the DPw of the insoluble alpha-glucan is about 35 to about 60.

6. The composition of claim 1, wherein the agent comprises an N-oxoammonium salt.

7. The composition of claim 1, wherein the rubber component comprises a diene-based sulfur-vulcanizable rubber or peroxide-vulcanizable rubber having a glass transition temperature (Tg) below −30° C. as determined by dynamic mechanical analysis.

8. The composition of claim 1, wherein the rubber component comprises natural rubber.

9. The composition of claim 1, wherein the rubber component comprises synthetic polyisoprene, styrene butadiene copolymer rubber, ethylene propylene diene monomer rubber, hydrogenated nitrile butadiene rubber, polybutadiene, or neoprene.

10. The composition of claim 1, wherein the rubber component comprises silicone rubber.

11. The rubber composition of claim 1, wherein the rubber composition comprises about 5 to about 100 parts-per-hundred of the oxidized insoluble alpha-glucan, wherein said parts-per-hundred is based on the weight of the rubber component in the composition.

12. The rubber composition of claim 1, wherein the rubber composition further comprises carbon black and/or silica.

13. The rubber composition of claim 1, wherein the rubber composition further comprises at least one of a filler, anti-oxidant, anti-ozonant, processing aid, compatibilizer, bonding agent, tackifier, curing agent, accelerator, or coupling agent.

14. The rubber composition of claim 1, wherein the rubber composition further comprises a polyetheramine.

15. The rubber composition of claim 1, wherein the rubber composition comprises a coupling agent that comprises
(i) an organic silane compound having a sulfide group, amino group, mercapto group, vinyl group, methacryl group, epoxy group, halogen, or alkoxy group, or
(ii) bis(3-triethoxysilylpropyl)tetrasulfide, bis(3-triethoxysilylpropyl)disulfide, bis(2-triethoxysilylethyl)tetrasulfide, 3-mercaptopropyl trimethoxysilane, 3-mercaptopropyl triethoxysilane, 3-nitropropyl trimethoxysilane, or 3-aminopropyl triethoxysilane.

16. The rubber composition of claim 1, wherein the rubber composition is a belt, seal, footwear, valve, tubing, mat, gasket, coating, film, or adhesive.

17. The rubber composition of claim 1, wherein the rubber composition is tire.

18. A method of producing a rubber composition of claim 1, said method comprising:
(a) providing an aqueous dispersion comprising a mixture said oxidized insoluble alpha-glucan and said rubber component,
(b) coagulating the dispersion/mixture to produce a coagulated mass, and
(c) optionally drying the coagulated mass.

19. The method of claim 18, further comprising:
(d) compounding the coagulated mass of step (b) or (c) with at least one rubber additive, optionally wherein the rubber additive is selected from a filler, anti-oxidant, anti-ozonant, processing aid, compatibilizer, bonding agent, tackifier, curing agent, accelerator, or coupling agent.
